(19) United States
(12) Patent Application Publication
(10) Pub. No.: US 2026/0290307 A1
(43) Pub. Date: Sep. 24, 2026

(54) SYSTEM

(71) Applicant: SoftBank Group Corp., Tokyo (JP)

(72) Inventor: Toshiyuki KATO, Tokyo (JP)

(73) Assignee: SoftBank Group Corp., Tokyo (JP)

(21) Appl. No.: 19/562,794

(22) Filed: Mar. 11, 2026

(30) Foreign Application Priority Data
Mar. 19, 2025 (JP) 2025-044467

(51) Int. Cl. G10L 13/027; G01C 21/20; G06F 40/151; G06F 40/166; G06F 40/205; G06F 40/284; G06N 3/0455; G06N 3/0475; G06V 30/10; G06V 30/40; G09B 21/00; G10L 13/10; G10L 15/02; G10L 15/16; G10L 25/18; G10L 25/24; G10L 25/63; G10L 25/90

(52) U.S. Cl. CPC G10L 13/027; G01C 21/206; G06F 40/151; G06F 40/166; G06F 40/284; G06N 3/0455; G06N 3/0475; G09B 21/006; G10L 13/10; G10L 15/02; G10L 15/16; G10L 25/18; G10L 25/24; G10L 25/63; G10L 25/90; G06F 40/205; G06V 30/10; G06V 30/40; G10L 2013/105

(57) ABSTRACT

A system includes a processor that is configured to receive a voice input from a user and analyze a speech signal corresponding to the voice input to convert the speech signal into text data, analyze the converted text data to extract important information and generate a summary based on the extracted important information, and convert the generated summary into audio data, recognize an emotional state of the user, and adjust an output of audio information based on the recognized emotional state.

### CROSS-REFERENCE TO RELATED APPLICATION

This application is based on and claims priority under 35 USC 119 from Japanese Patent Application No. 2025-044467 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Users with visual impairments or intellectual disabilities often face significant difficulties in understanding, remembering, and following information that is necessary for performing daily tasks and professional duties. Conventional assistive technologies either provide simple text-to-speech conversion without context awareness, or offer limited interaction that does not adapt to the user's emotional state or level of comprehension. As a result, visually impaired users may not efficiently grasp the key points of meeting agendas or work manuals, and users with intellectual disabilities may struggle to recall rarely used procedures or tools, leading to errors, decreased productivity, and psychological stress.

Furthermore, conventional systems typically do not analyze a user's spoken input to automatically extract important information, generate summaries, and then provide adaptive audio feedback based on the user's emotional condition. There is a need for a system that can accept speech input, convert it into text, extract important information to generate summaries, and then provide audio output whose content and presentation are adjusted according to the emotional state of the user. There is also a need for such a system to specifically support visually impaired users and users with intellectual disabilities in reviewing meeting agendas, work manuals, and infrequently used procedures in an accessible and emotionally adaptive manner.

### SUMMARY

In order to solve at least part of the above-described problems, a system according to one aspect of the present invention comprises a processor, wherein the processor is configured to receive a voice input from a user and analyze a speech signal corresponding to the voice input to convert the speech signal into text data, analyze the converted text data to extract important information and generate a summary based on the extracted important information, and convert the generated summary into audio data, recognize an emotional state of the user, and adjust an output of audio information based on the recognized emotional state.

In one embodiment, the processor is configured to convert, into audio information, at least one of a meeting agenda and a work manual that a visually impaired user needs to review in advance. By converting such documents into audio and optionally summarizing their content, the system enables the visually impaired user to efficiently understand the key points and prepare for meetings or tasks.

In another embodiment, the processor is configured to provide, as audio information, at least one of information that is likely to be forgotten by a user with an intellectual disability and usage instructions of a tool that is rarely used by the user with the intellectual disability. By generating and outputting such audio information, potentially including summarized and emotionally adjusted instructions, the system supports the user with an intellectual disability in recalling necessary procedures and correctly operating tools that are not frequently used.

The term “system” refers to an arrangement of hardware and software components, including at least one processor and associated memory and interfaces, that cooperatively perform the functions described in the claims.

The term “processor” refers to one or more hardware processing units, such as a central processing unit (CPU), microprocessor, digital signal processor (DSP), application specific integrated circuit (ASIC), or programmable logic device, configured to execute instructions to perform the claimed operations.

The term “user” refers to a human individual who interacts with the system, including but not limited to a visually impaired user or a user with an intellectual disability.

The term “voice input” refers to an acoustic signal generated by speech of the user and captured by a microphone or equivalent input device.

The term “speech signal” refers to a digital or analog representation of the user's voice input suitable for analysis and processing by the processor.

The term “text data” refers to a machine-readable sequence of characters representing linguistic content derived from analysis of the speech signal.

The term “analyze a speech signal” refers to performing one or more signal processing or pattern recognition operations on the speech signal, including but not limited to feature extraction, acoustic modeling, and decoding, to derive corresponding text data.

The term “analyze the converted text data” refers to processing the text data using one or more natural language processing, linguistic, or rule-based techniques to identify structure, meaning, and context within the text data.

The term “important information” refers to a subset of information contained in the text data that is determined, based on predetermined rules, models, or heuristics, to be salient, relevant, or representative of the main content.

The term “summary” refers to text data generated from the important information that represents a condensed version of the original content while preserving key points or essential meaning.

The term “generate a summary” refers to producing summary text from the converted text data by selecting, compressing, rephrasing, or otherwise transforming the important information.

The term “audio data” refers to digital data representing sound, including but not limited to waveform samples, encoded audio streams, or files in formats such as WAV or MP3, suitable for playback to the user.

The term “convert the generated summary into audio data” refers to performing text-to-speech processing or equivalent synthesis operations on the summary to obtain an audio representation of the summary.

The term “emotional state of the user” refers to a psychological condition of the user, such as happiness, sadness, stress, calmness, confusion, or other affective states, inferred or recognized by the system based on one or more inputs, including but not limited to voice characteristics or interaction patterns.

The term “recognize an emotional state of the user” refers to analyzing one or more input signals or interaction histories to classify, estimate, or infer the emotional state of the user.

The term “audio information” refers to content, including but not limited to speech, announcements, explanations, or instructions, that is output as sound to the user and represented internally as audio data.

The term “adjust an output of audio information” refers to modifying one or more aspects of the audio information or its presentation, including content, sequence, speaking rate, volume, tone, or emphasis, based on the recognized emotional state of the user.

The term “meeting agenda” refers to a document or data structure describing topics, schedules, or items to be discussed in a meeting.

The term “work manual” refers to a document or data structure describing procedures, policies, or instructions related to occupational tasks or job functions.

The term “visually impaired user” refers to a user who has a visual disability, including low vision or blindness, that limits the user's ability to read or perceive visual information in a conventional manner.

The term “convert, into audio information, a meeting agenda or a work manual” refers to processing text or structured content from the meeting agenda or work manual and generating corresponding audio data that can be output as spoken information to the user.

The term “information that is likely to be forgotten” refers to content, such as steps, rules, or reminders, that the system or a designer has identified, based on prior knowledge, configuration, or usage patterns, as having a higher probability of not being retained or recalled by the user.

The term “user with an intellectual disability” refers to a user who has limitations in intellectual functioning and adaptive behavior that affect conceptual, social, or practical skills, and who may require additional support for understanding or remembering information.

The term “usage instructions of a tool” refers to explanatory content describing how to operate, configure, maintain, or safely use a physical or software tool, device, or instrument.

The term “tool that is rarely used” refers to a tool whose usage frequency by the user is low, for example because it is only needed for specific tasks or occasional operations, and for which the user may have difficulty remembering the proper usage procedure.

The term “provide, as audio information, information that is likely to be forgotten or usage instructions of a tool” refers to generating and outputting audio data that verbally communicates such information or instructions to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

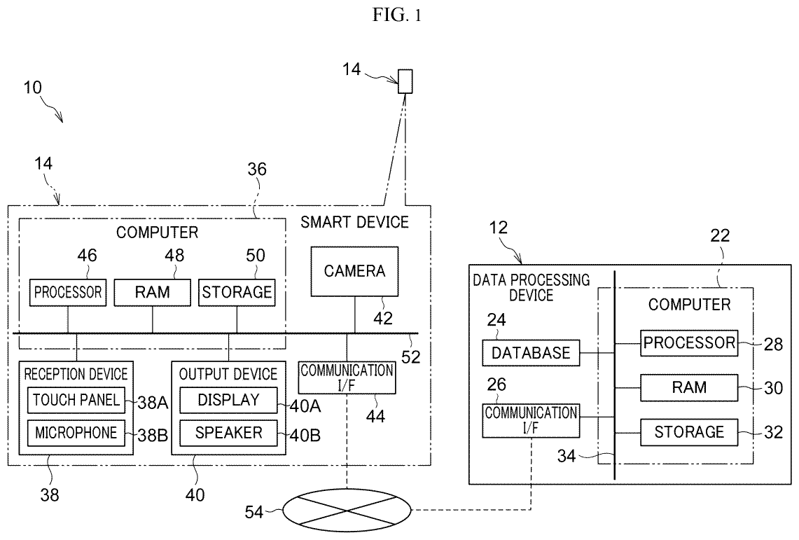

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

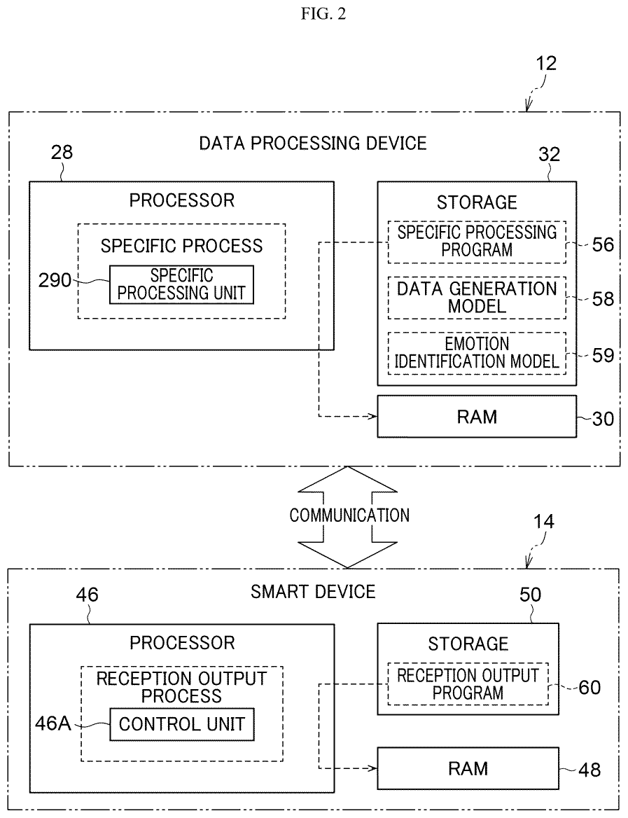

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer systems that provide audio guidance or summaries for users with disabilities typically implement fixed, rule-based pipelines: a speech recognizer converts audio to text, a static summarization module or template engine compresses or reformats the text, and a text-to-speech engine generates audio output. These pipelines are usually designed for a generic user and do not flexibly adapt either (i) the internal text processing logic or (ii) the speech output characteristics to different types of users or different task contexts. As a result, such systems often fail to provide information in a form that is optimally accessible to visually impaired users or intellectually disabled users.

From a computer-technology standpoint, the conventional architectures exhibit several technical limitations. First, text processing components do not exploit generative artificial intelligence models in a structured manner; they lack a systematic mechanism for constructing and supplying context-aware prompt sentences, and therefore cannot dynamically adjust the summarization or simplification behavior of the model according to the type of requested processing. Second, the control flow between text processing and speech synthesis is generally static: the same summarization depth, linguistic complexity, and speech parameters (such as speed, prosody, and emphasis) are applied regardless of user attributes, device capabilities, and usage situations. Third, existing systems typically do not maintain an integrated representation of input information, processing request types, user attribute information, and usage situation information that can be used to drive end-to-end adaptation of both generative model behavior and audio output.

Because of these limitations, the overall computing system is unable to efficiently transform heterogeneous input information (for example, meeting information, work procedure information, or explanation information for rarely used work instruments) into optimized output information for specific user groups. The lack of dynamic control over prompt sentences, generative AI behavior, and audio synthesis parameters leads to unnecessary computational work, redundant network traffic, and sub-optimal utilization of processing resources on the server and terminal. It also results in information outputs that are either overly verbose, too complex, or not aligned with the accessibility requirements of visually impaired users and intellectually disabled users.

Accordingly, there is a need for an improved computer-implemented system that: (i) programmatically generates and manages prompt sentences for a generative information processing model based on processing request types and input information, (ii) integrates generative text processing and speech synthesis in a coordinated control flow, and (iii) dynamically adapts both the generative model behavior and the speech synthesis conditions to user attribute information and usage situation information. Such a system should improve the functioning of the server itself by optimizing how text is summarized or simplified, how audio is synthesized, and how processed results are delivered to terminals, thereby enabling more efficient and effective support for users with disabilities.

The specific processing by the specific processing unit 290 of the data processing device 12 in Example 1 is realized by the following means.

The present invention provides a server comprising a processor and at least one storage device storing instructions that, when executed by the processor, cause the processor to acquire input information including character information or audio information from a user, receive a processing request type together with the input information, convert the audio information into character information by audio analysis processing or convert the character information into standardized character information by format conversion processing, generate a prompt sentence that designates at least one of summarization processing and simplification processing based on the processing request type and the input information, generate generation input data including the prompt sentence and the input information, input the generation input data to a generative information processing model to generate summary character information or easy-to-understand character information from long character information, convert the summary character information or the easy-to-understand character information into audio information by speech synthesis processing to generate audio data corresponding to an output medium, dynamically change at least one of the prompt sentence for the generative information processing model and an audio output condition of the speech synthesis processing based on user attribute information or usage situation information to determine an information output mode adapted to at least one of a visually impaired user and an intellectually disabled user, and transmit at least one of the audio data and the summary character information or the easy-to-understand character information to a terminal via a communication path so that the terminal reproduces or displays the transmitted data. This enables an improvement in computer functionality by providing an adaptive, server-centric processing pipeline in which prompt generation, generative AI-based text transformation, and speech synthesis are jointly controlled in response to structured processing request types and user-specific context, thereby optimizing resource usage on the server, reducing unnecessary data transfer, and delivering output information in formats that are computationally tailored to accessibility requirements of visually impaired users and intellectually disabled users.

The term “processor” refers to a hardware processing circuitry, such as a central processing unit or other information processing circuitry, configured to execute instructions stored in at least one storage device to perform the functions described herein.

The term “storage device” refers to a physical memory component, such as a semiconductor memory or magnetic storage, configured to store instructions and data used by the processor.

The term “input information” refers to information received from a user or a terminal, the information including at least one of character information and audio information to be processed by the processor.

The term “character information” refers to information expressed as text data, including letters, symbols, numbers, or combinations thereof, in a machine-readable format.

The term “audio information” refers to information expressed as audio data, including at least one of voice signals and other sound signals that can be analyzed or synthesized by the processor.

The term “processing request type” refers to control information indicating a category or purpose of processing requested by a user, including, for example, meeting information processing, work procedure information processing, or explanation information processing for a work instrument.

The term “audio analysis processing” refers to processing that analyzes audio information to detect linguistic content and converts the audio information into character information.

The term “format conversion processing” refers to processing that converts character information from an original data format to a standardized data format suitable for subsequent text analysis or transformation.

The term “standardized character information” refers to character information whose format, encoding, and structure have been normalized or unified to a predefined standard so as to facilitate consistent processing by the processor.

The term “prompt sentence” refers to a control text or instruction text that specifies at least one of a processing objective, a processing style, or constraints for a generative information processing model with respect to given input information.

The term “generation input data” refers to data provided to a generative information processing model, the data including at least the prompt sentence and the input information to be transformed by the model.

The term “generative information processing model” refers to a machine-implemented model, such as a generative artificial intelligence model, configured to generate new character information, including summary character information or easy-to-understand character information, based on the generation input data.

The term “long character information” refers to character information having a length or complexity above a predetermined threshold, such as a long document, a detailed procedure description, or an extended explanation.

The term “summary character information” refers to character information that represents a condensed form of long character information, the condensed form retaining main points or essential content while omitting less important details.

The term “easy-to-understand character information” refers to character information that has been simplified in at least one of vocabulary, sentence structure, and amount of detail so as to be more easily understood by a user with reduced cognitive ability.

The term “speech synthesis processing” refers to processing that converts character information into audio information representing synthetic speech.

The term “audio data” refers to digital data representing audio information in a format suitable for storage, transmission, or reproduction by an output device.

The term “output medium” refers to a device or interface through which audio data or character information is presented to a user, including at least one of a speaker, headphone, display, or other user interface device.

The term “user attribute information” refers to information indicating characteristics of a user, including at least one of a disability type, preference information, language preference, or skill level that can influence information output mode.

The term “usage situation information” refers to contextual information relating to a usage environment or usage purpose of the system, including at least one of a task type, a usage frequency, a device capability, or a time constraint.

The term “information output mode” refers to a configuration of output parameters, including at least one of summarization depth, linguistic complexity, and speech synthesis conditions, that determines how information is presented to a user.

The term “visually impaired user” refers to a user having a visual disability that limits the user's ability to perceive information presented visually on a display.

The term “intellectually disabled user” refers to a user having a cognitive disability that limits the user's ability to understand or remember complex information presented in standard form.

The term “communication path” refers to a logical or physical communication link, including at least one of a wired network and a wireless network, used to transmit data between the server and a terminal.

The term “terminal” refers to an information processing apparatus, such as a personal computer, a portable information device, or another user interface device, configured to communicate with the server, and to reproduce or display received data.

In one embodiment, a server provides a concrete implementation of the system previously described in the claims. The server includes a processor, a main memory, a non-volatile storage device, a network interface, and an audio interface. The processor executes computer-readable instructions stored in the storage device to implement modules including at least an input acquisition module, a text normalization module, a prompt generation module, a generative text processing module, a speech synthesis control module, a user context management module, and a transmission module. The server communicates with a terminal operated by a user via a wired or wireless network. The terminal includes a display, a speaker or headphones, and an input interface operated by the user.

The server uses commercial or open-source software components to realize the modules. For example, the server can run a web application framework such as a generic HTTP server framework on an operating system such as a generic server operating system. The server can execute a generative AI model implemented as a transformer-based neural network, and can use a speech synthesis engine, such as a generic text-to-speech engine, which may be provided as a cloud service or as an on-premise library. The server can also use a speech recognition engine as part of the audio analysis processing when the user supplies audio information.

In one concrete configuration, the server stores a generative AI model that follows a multi-layer transformer architecture. The model includes a token embedding layer that maps text tokens into dense vectors, a positional encoding mechanism to represent token order, a plurality of self-attention layers that compute attention scores between tokens, and feedforward neural network layers that transform the intermediate representations. The model parameters include weight matrices for attention (query, key, value matrices), weight matrices for feedforward layers, and bias vectors. The server stores these parameters in the storage device and loads them into the main memory when the model is executed.

The server defines a specific input data structure for the generative AI model. The server represents the generation input data as a sequence of token identifiers: a system-role prefix that encodes the processing request type, followed by a prompt sentence, and followed by the original character information. For example, the server can construct an input sequence such as:
“[ROLE:SUMMARY] Summarize the following text in simple language in about 5 bullet points. Focus on main tasks and safety precautions. [TEXT] . . . (original text) . . . ”.
Alternatively, the server can construct an input sequence such as:
“[ROLE:SIMPLIFY] Rewrite the following text so that it is easy to understand for an intellectually disabled person. Use short sentences and simple words. [TEXT] . . . (original text) . . . ”.

By encoding the processing request type and the prompt sentence as part of a structured token sequence, the server causes the generative AI model to condition its output on explicit control instructions, rather than merely compressing or rephrasing text in a generic way.

The server uses a specific training and inference method for the generative AI model. During training, the server or an associated training system uses training data pairs consisting of input sequences (prompt sentences plus source text) and target sequences (desired summary text or simplified text). The server defines a loss function, such as a cross-entropy loss over predicted token distributions compared with target tokens. The server updates the model parameters by backpropagation and a gradient-based optimizer, such as a variant of stochastic gradient descent or an adaptive learning-rate optimizer. The server may apply data augmentation techniques, such as random truncation of long texts, synonym replacement, or re-ordering of non-critical clauses, to increase robustness of the summarization and simplification behavior.

By explicitly training on prompt-conditioned tasks, the server ensures that the model reacts predictably to different prompt sentences and processing request types.

The server manages specific technical features to improve computing performance. The server stores user attribute information and usage situation information in a structured database. For example, the server maintains a user profile table containing fields such as user identifier, disability type, preferred language, preferred summarization level, preferred speech rate, and preferred pitch range. The server also maintains a usage context table containing recent processing request types, document categories (meeting information, work procedure information, work instrument explanation), and device capability indicators (terminal screen size, audio bandwidth, network latency). The server loads these data into a memory-resident cache for fast access when generating prompt sentences and selecting audio synthesis parameters.

The server uses the user context management module to compute an information output mode. The server defines an algorithm that maps user attribute information and usage situation information to: (i) a prompt template identifier, (ii) a target summarization length, (iii) a target reading complexity level, and (iv) speech synthesis parameters (speech rate, pitch, volume, pause insertion). For example, when the user is a visually impaired user with normal cognitive ability, the server may select a prompt sentence emphasizing coverage of all agenda items and more detailed steps, and may choose a normal speech rate. When the user is an intellectually disabled user, the server may select a prompt sentence emphasizing reduced complexity and a step-by-step structure, and may choose a slower speech rate and longer pauses. This algorithm is implemented as a deterministic mapping, such as a set of rules or a small decision tree, and is executed by the processor. This constitutes more than a simple human replacement; it establishes a new control logic for coordinating generative text processing and speech synthesis based on structured context data, which improves the functioning of the server.

The server implements the prompt generation module as a procedural component that constructs prompt sentences using parameterized templates. The server selects a template according to the processing request type, such as:
“Summarize the following text in simple English in about 5 bullet points. Focus on the main tasks and safety precautions.”
“Rewrite the following text so that it is easy to understand for an intellectually disabled person. Use short sentences, simple words, and step-by-step instructions.”
“Summarize the following meeting agenda in about 300 characters, focusing on the main decisions and action items.”

The server fills the template with parameters such as target length, language, and difficulty level. This structured prompt generation reduces ambiguity in the input to the generative AI model and improves consistency and accuracy of the generated text. Because the server centralizes prompt template management and dynamically selects templates based on user and context data, the server can reduce the number of model calls and avoid unnecessary re-processing of texts that do not require simplification or deep summarization.

The server uses the text normalization module to convert various input formats (plain text, office document formats, or PDF-derived text) into standardized character information. The server can use a general document parsing library to extract text from files, then applies normalization steps such as removal of control characters, normalization of whitespace, conversion of full-width and half-width characters into a unified form, and segmentation of headings and paragraphs. The server can represent the normalized text as a structured data object, with metadata fields indicating the document type (meeting information, work procedure information, work instrument explanation), section boundaries, and heading levels.

The server can use this structure to focus summarization on particular sections, thereby improving computational efficiency and relevance.

The server integrates the generative text processing module with the speech synthesis control module to achieve a coordinated technical effect. After the generative AI model outputs summary character information or easy-to-understand character information, the server applies additional processing to insert markers for reading pauses, emphasis tags for important phrases, and section boundaries. The server may convert these markers into a markup language supported by the speech synthesis engine, such as a general speech synthesis markup language. By doing so, the server enables the speech synthesis engine to generate audio with improved prosody and intelligibility, especially for long or complex texts that have been simplified. This technical integration between text-level structure and audio prosody cannot be trivially replicated by manual reading and goes beyond a generic automation of human speech; it uses the internal structure produced by the generative AI model to control machine speech generation at a fine-grained level.

The server implements memory and network optimizations to reduce computational load and communication overhead. For example, the server caches intermediate generative AI outputs keyed by a hash of the original normalized text and the processing request type. If the same user or a different user later requests a similar operation on the same document, the server can reuse previously generated summary character information or easy-to-understand character information, possibly with only minor adjustments to prompt sentences or speech synthesis parameters. This avoids re-running expensive generative model inference and thus improves processing speed and reduces energy consumption. The server also compresses audio data and text data when transmitting them to the terminal, using standard compression algorithms, to reduce network bandwidth usage and latency.

The server, in one embodiment, applies a non-standard control strategy for splitting long documents before feeding them to the generative AI model. The server measures the token length of the normalized text and, when the length exceeds a threshold, splits the text into segments at natural boundaries such as section headings or paragraph breaks. The server then generates intermediate summaries for each segment and a higher-level summary over the intermediate summaries. This hierarchical summarization algorithm reduces the length of the model input at each step, improving both processing speed and summarization accuracy, since the model can focus attention on a limited context. The server coordinates the hierarchical summarization with the prompt generation, using prompt sentences that explicitly instruct the model to summarize “this section only” at the lower level and “summaries of sections” at the higher level. This approach yields a technical improvement in how generative AI models are utilized in a resource-constrained environment.

The server uses the speech synthesis control module to adapt audio output conditions in a non-conventional manner. Instead of using a fixed speech rate and volume for all users and texts, the server determines an audio output condition profile based on user attribute information and the structural complexity of the output text. For example, when the output text contains many technical terms or multi-step procedures, the server selects a slower speech rate and inserts longer pauses between sentences or steps. The server may calculate a complexity score from factors such as average sentence length, number of subordinate clauses, or frequency of domain-specific terms. This complexity score is transformed into parameter values for the speech synthesis engine. As a result, the server improves comprehension by matching the temporal structure of audio output to the linguistic complexity of the text and needs of the user.

The terminal cooperates with the server in a way that leverages these server-side technical improvements. The terminal receives summary character information or easy-to-understand character information and audio data from the server and presents them to the user. The terminal can display the text with adjustable font size and color contrast and can synchronize text highlighting with audio playback using time stamps or markup embedded in the audio data or a separate control file. When the user taps a sentence in the text, the terminal can send a request to the server specifying that sentence as a focus region; the server can then generate a more detailed explanation of that region using a new prompt sentence, such as:
“Explain the following step in more detail using very simple sentences, and list sub-steps clearly: . . . (sentence) . . . ”.

The server returns a concise explanation and corresponding audio, and the terminal displays and plays them. This interactive mechanism exemplifies how the system, as a whole, achieves a technical interaction pattern between server, terminal, and generative AI model, which cannot be easily replicated by static documents or fixed audio recordings.

The user typically interacts with the system by selecting files, choosing processing modes, and issuing natural-language requests that serve as high-level prompt specifications. The user may input phrases such as:
“I want to check the meeting agenda by audio.”
“Please explain how to use this tool by audio.”
“Please summarize this manual so that I can understand the main points quickly.”

In response, the server translates these user-level phrases into internal processing request types and structured prompt sentences. This translation is realized by the processor using rule-based mapping and optionally a lightweight classifier. The technical value arises from this mapping layer, which transforms loosely structured natural-language commands into stable and explicit control parameters for the generative AI model and speech synthesis engine.

Alternative embodiments can vary in the placement of the generative AI model. In one embodiment, the model is executed locally on the server using a hardware accelerator such as a graphics processing unit or a tensor processing unit. In another embodiment, the server acts as a client of an external generative AI service, encapsulating network communication inside the generative text processing module. In both cases, the server maintains control over prompt generation, context management, segmentation strategy, and speech synthesis configuration.

This server-centric control ensures that improvements in processing speed, accuracy, and accessibility are preserved regardless of where the model parameters physically reside.

In yet another embodiment, the server can run more than one generative AI model, each specialized for a different purpose, such as short summarization, detailed summarization, and simplification for intellectually disabled users. The server can select a model according to the processing request type, document category, and user attribute information. The server can also implement a fallback rule such that if a specialized model fails or exceeds a time budget, a more compact model is used. This multi-model orchestration further improves robustness and processing speed.

Across these embodiments, the system does not simply automate human summarization or reading. The server introduces novel data structures for combining prompt sentences, processing request types, and user context; implements non-standard control flows for splitting, summarizing, and simplifying long documents; and tightly couples generative AI outputs with speech synthesis parameters. These measures collectively improve the performance, scalability, and accessibility characteristics of the computing system itself, thereby providing a concrete technical solution that goes beyond an abstract idea or a generic business process.

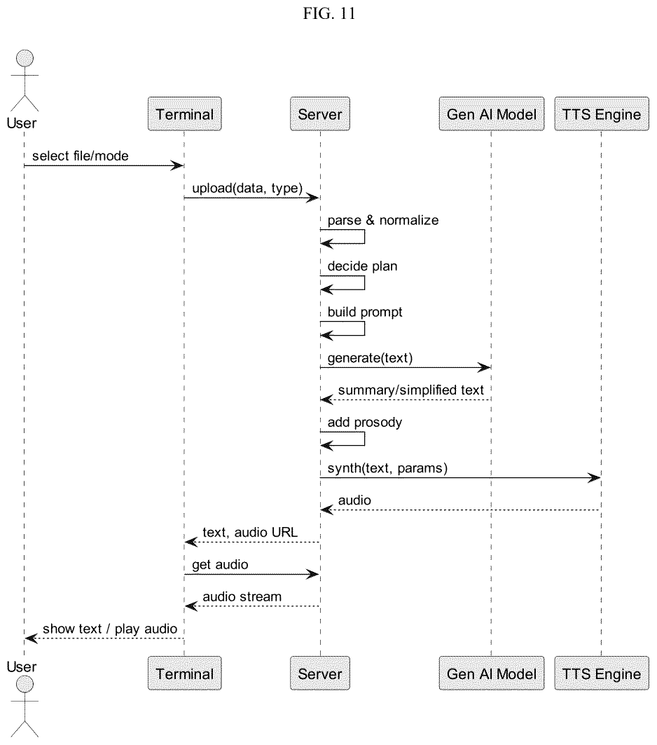

The following describes the processing flow using FIG. 11.

Step 1:
User operates the terminal to provide input information and a processing request type.
User selects a file containing character information (for example, a meeting agenda or work procedure document) or records audio information via a microphone of the terminal. User chooses a processing mode on the terminal UI (for example, “summarize and read aloud,” “simplify for easy understanding,” or “read full text”).
Input: raw character information or raw audio information, and a processing request type selected by the user.
Output: an HTTP or similar request sent from the terminal toward the server, containing the input information and the processing request type, encoded as multipart/form-data or a structured payload.

Step 2:
Terminal transmits the input information and the processing request type to the server.
Terminal encapsulates the selected file or recorded audio in a network request together with the processing request type and optional user-level instructions. The terminal performs data encoding, attaches headers (content type, authorization, etc.), and sends the request over a communication path such as a wired or wireless network.
Input: user-provided data (file data or audio stream), processing request type, and optional natural-language instruction text.
Output: a network-layer data packet stream that reaches the server and is ready to be processed by the server's network interface.

Step 3:
Server receives the network request and extracts the raw input information and the processing request type.
Server, via a web framework, accepts the HTTP request, parses headers and body, and separates the payload parts. The server identifies whether the payload contains character information, audio information, or both, and obtains the processing request type flag. The server may validate file type and size.
Input: incoming network packets containing encoded input information and processing request type.
Output: internal data objects representing raw character information or raw audio information and a normalized processing request type stored in server memory.

Step 4:
Server converts audio information into character information or normalizes existing character information.
Server, when the input information includes audio information, calls a speech recognition engine to perform audio analysis processing, decoding audio waveforms into text. When the input information is already in a text file format, the server uses a document parsing library to extract text and applies normalization, such as removing control codes, unifying character encodings, and segmenting paragraphs.
Input: raw audio information and/or raw character information.
Output: standardized character information, represented as a text string or structured text object suitable for further analysis.

Step 5:
Server determines whether summarization or simplification, or both, are required based on the processing request type and context.
Server inspects the processing request type (for example, “meeting information,” “work procedure,” “tool usage explanation”), user attribute information (for example, visually impaired user, intellectually disabled user), and usage situation information (for example, first-time request, repeated request, device capability). The server applies a rule-based decision algorithm to decide whether to perform summarization, simplification, or direct reading.
Input: processing request type, standardized character information, user attribute information, and usage situation information.
Output: an internal processing plan indicating which operations (summarization, simplification, both, or none) need to be applied, and related parameters such as target summary length and complexity level.

Step 6:
Server generates a prompt sentence and constructs generation input data for the generative AI model.
Server selects a prompt template corresponding to the processing plan, such as a summarization template or a simplification template. The server fills parameters like target length, focus (decisions, tasks, safety), and difficulty level. For example, the server may generate a prompt sentence such as:
“Summarize the following text in simple English in about 5 bullet points. Focus on the main tasks and safety precautions.”or
“Rewrite the following text so that it is easy to understand for an intellectually disabled person. Use short sentences, simple words, and step-by-step instructions.”
Server then concatenates the prompt sentence with the standardized character information into a structured input sequence suitable for tokenization by the generative AI model.
Input: processing plan, standardized character information, and user/context parameters.
Output: a prompt sentence and a generation input data structure that combines the prompt sentence and the standardized character information.

Step 7:
Server executes the generative AI model to produce summary character information or easy-to-understand character information.
Server tokenizes the generation input data into token IDs, feeds the tokens into the generative AI model implemented as a transformer-based neural network, and performs feedforward computations across attention layers and feedforward layers. The server uses stored model parameters (weight matrices and biases) to compute attention scores, generate context-aware token representations, and decode output tokens. The server then detokenizes the output tokens into text.
Input: generation input data (prompt sentence plus standardized character information) encoded as token sequences.
Output: generated character information, which is either summary character information or easy-to-understand character information, represented as text strings.

Step 8:
Server post-processes the generated character information and, if necessary, merges it with original text segments.
Server trims extraneous markers, ensures sentence boundaries are correct, and aligns section headings if hierarchical summarization was used. When the input text was split into multiple segments, the server may aggregate segment-level summaries into a higher-level summary by concatenating or further summarizing them with a second pass of the generative AI model using a prompt sentence such as:
“Summarize the following section summaries into a single overall summary focusing on decisions and deadlines.”
Input: generated character information for one or more segments, and optionally original section metadata.
Output: final summary character information or final easy-to-understand character information, ready for audio conversion and/or display.

Step 9:
Server computes an information output mode and corresponding speech synthesis parameters.
Server uses user attribute information (for example, disability type, preferred speed) and usage situation information (for example, complexity score of the generated text, type of document) to determine an information output mode. The server calculates a complexity score from factors such as average sentence length and domain-specific term frequency, and maps this score to parameters including speech rate, pitch, volume, and pause duration.
Input: final generated character information, user attribute information, usage situation information, and internal rules for mapping to output modes.
Output: an information output mode definition and a set of speech synthesis parameters tailored to at least one of a visually impaired user and an intellectually disabled user.

Step 10:
Server prepares the text for speech synthesis by inserting structural markers and prosody hints.
Server analyzes the final generated character information, identifies sentences, list items, and key phrases, and inserts markers or tags representing pauses, emphasis, or section boundaries.
The server formats the text into a markup language accepted by the speech synthesis engine.
This involves data processing that assigns additional attributes (pause length, emphasis level) to segments of the text to enhance intelligibility.
Input: final generated character information and speech synthesis parameters.
Output: speech-ready text with embedded prosodic markers, in a format suitable for the speech synthesis engine.

Step 11:
Server invokes the speech synthesis engine to convert the speech-ready text into audio data.
Server sends the speech-ready text and the speech synthesis parameters (language, voice type, speech rate, pitch, volume, audio format) to a text-to-speech component. The speech synthesis engine performs waveform generation or concatenation based on internal acoustic and prosodic models and returns an audio stream. The server receives this stream and encodes it into a desired audio format such as MP3 or WAV.
Input: speech-ready text with prosodic markers and speech synthesis parameters.
Output: audio data representing the spoken version of the generated character information.

Step 12:
Server stores processed results and generates references for later reuse.
Server writes the final summary character information or easy-to-understand character information and the corresponding audio data to a storage device, along with metadata such as a job identifier, user identifier, processing request type, and timestamps. The server also stores a hash of the original standardized character information to detect future reuse opportunities.
Input: audio data, final generated character information, and associated metadata.
Output: persistent records in storage, including file paths or object identifiers and indices for fast lookup.

Step 13:
Server transmits processed data to the terminal for reproduction and display.
Server constructs a response message that includes the final generated character information, a reference (such as a URL) to the stored audio data, and information about the information output mode. The server may compress the data for efficient network transfer and then sends the response via the communication path.
Input: stored or in-memory final generated character information, audio data reference, and output mode information.
Output: a network response that delivers the processed text and audio reference to the terminal.

Step 14:
Terminal receives the processed data and presents it to the user.
Terminal parses the server response, extracts the final generated character information and the audio reference, and updates the user interface. The terminal displays the text in a readable format and requests the audio data from the server using the provided reference. The terminal then uses a local audio playback component to stream or play the audio, allowing the user to listen, pause, or replay.
Input: server response containing final generated character information and audio reference, and subsequently retrieved audio data.
Output: visual display of the text on the terminal and audible output of the corresponding speech through the terminal's speaker or connected audio device.

Step 15:
User performs follow-up interactions and issues additional processing requests based on the presented information.
User may, after listening or reading, request a finer summarization, a more detailed explanation, or repetition of specific parts by selecting UI elements or entering natural-language commands such as “Explain step 3 in more detail” or “Summarize only the decisions and deadlines.” Terminal forwards these follow-up requests to the server as new processing request types associated with the same source document or a specific text segment.
Input: user follow-up commands, selected text positions or sections, and identifiers of prior processing results.
Output: new requests sent from the terminal to the server, which trigger a new iteration of the processing steps with adjusted prompt sentences and processing plans.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented assistance systems for visually impaired users and intellectually disabled users generally perform a simple pipeline of speech recognition, fixed rule-based text processing, and speech synthesis. These systems typically convert user speech to text, look up pre-authored responses or template-based instructions, and then convert such responses to audio. As a result, several technical problems arise in the operation of the underlying computing systems.

First, the processing pipeline is not optimized to generate guidance content that is adapted to the cognitive and perceptual needs of visually impaired users and intellectually disabled users.

In many implementations, a general-purpose speech recognizer feeds into a generic text engine, which outputs long, complex sentences. When such sentences are directly passed to a speech synthesizer, the resulting audio output often exceeds the attention span or comprehension capability of the intended user. This leads to repeated interactions, additional recognition cycles, and increased network traffic, thereby consuming more processor time and memory resources and worsening latency.

Second, conventional navigation systems for indoor environments, such as stores or public facilities, typically focus on visual map rendering or basic turn-by-turn text instructions. They do not tightly integrate indoor route computation with dynamic generation of simplified, user-tailored verbal guidance. When route computation and guidance generation are not co-designed, the server must perform separate data transformations for routing and for explanation, repeatedly building and parsing intermediate structures. This fragmented design increases CPU load, introduces redundant data conversions, and complicates error handling.

Third, existing text summarization or content adaptation mechanisms in accessibility systems tend to be either static (pre-written short descriptions) or use generic summarization algorithms that do not consider the specific structure of route information and attribute information of items (such as merchandise or tools). These approaches lack a dedicated mechanism for constructing a machine-readable prompt to a generative AI model that encodes constraints on speech style, difficulty level, and content selection. Without such a mechanism, the generative model may output unnecessarily long or inconsistent text, thereby increasing the computational cost of subsequent speech synthesis and forcing the user terminal to handle large audio payloads.

Fourth, many accessibility solutions are designed as application-layer features that sit on top of generic computing platforms without improving the underlying computer's functional efficiency. For example, simply overlaying screen reader features on top of conventional navigation or catalog systems does not reduce the number of processing steps or network round trips. As a result, server-side and client-side processors execute multiple independent modules that duplicate functionality, such as parallel formatting of route data and product data, which leads to suboptimal use of hardware resources and slower end-to-end response times.

Accordingly, there is a need for an improved computer-implemented system that (i) coordinates speech recognition, indoor route computation, and item attribute retrieval, (ii) constructs structured prompt sentences encoding route and attribute information with explicit style and difficulty constraints, (iii) leverages a generative AI model in a controlled manner to produce concise guidance text tailored to visually impaired users and intellectually disabled users, and (iv) converts such guidance text into compact audio output. Such a system should reduce redundant data transformations, lower computation and communication overhead, and improve the responsiveness and usability of the overall computer platform when providing real-time navigation and information guidance in complex facilities.

The specific processing by the specific processing unit 290 of the data processing device 12 in Application Example 1 is realized by the following means.

The present invention provides a server comprising a processor and a memory storing instructions which, when executed by the processor, cause the processor to receive audio input from a user and acquire acoustic data; convert the acoustic data into character string data by performing speech recognition processing; analyze the character string data to identify a request content of the user and a target item, and acquire a section position corresponding to the target item; calculate a route within a facility on the basis of the section position and a user position, and generate route information relating to the route within the facility; acquire attribute information relating to the target item from an information storage unit; generate a prompt sentence including explanation information comprising the route information and the attribute information, and including constraint conditions regarding a speech style and a difficulty level; input the prompt sentence to a generative information processing model and cause the generative information processing model to generate a summarized text for a visually impaired person or an intellectually disabled person on the basis of the explanation information; convert the summarized text into acoustic data by performing speech synthesis processing; and output the acoustic data as guidance speech via an output device to support movement of the user and understanding of the target item. This enables an integrated and technically efficient processing pipeline in which the server's computing resources are used to jointly derive navigation paths and item descriptions, encode them into a structured prompt sentence with explicit style and difficulty constraints, obtain a concise and user-adapted summarized text from a generative AI model, and synthesize compact audio output, thereby reducing redundant data transformations, decreasing processing load and network bandwidth consumption, and improving latency and usability of computer-based assistance for visually impaired users and intellectually disabled users in complex environments.

The term “audio input” refers to sound data, including spoken utterances of a user, captured by an input device such as a microphone and provided to the system for processing.

The term “acoustic data” refers to a digital representation of audio input, including raw or encoded waveform samples that can be processed by a speech recognition module.

The term “speech recognition processing” refers to computational processing that analyzes acoustic data and outputs character string data representing a textual transcription of spoken content.

The term “character string data” refers to textual data composed of characters or symbols that represent words or phrases obtained from speech recognition processing.

The term “request content” refers to a semantic representation of an intention or demand expressed by a user, such as a request to locate an item or obtain information about the item.

The term “target item” refers to a physical or logical object that is the subject of the user's request, including but not limited to merchandise, tools, equipment, or other tangible articles.

The term “section position” refers to data representing a location or region within a facility, such as a shelf area, aisle, or zone, where a target item is stored or displayed.

The term “user position” refers to data representing the current or estimated location of the user within a facility, expressed as coordinates, a node in a graph, or any other positional descriptor.

The term “route within a facility” refers to a path or sequence of positions connecting a user position to a section position, computed with reference to layout information of a facility such as a store, business site, or public facility.

The term “route information” refers to data describing a route within a facility, including but not limited to waypoints, directions, distances, or step-by-step movement instructions.

The term “information storage unit” refers to any hardware or software component configured to store and provide data, including databases, storage devices, or memory structures that hold attribute information or layout information.

The term “attribute information” refers to descriptive data associated with a target item, including but not limited to category, function, usage method, price, size, composition, or other characteristics.

The term “prompt sentence” refers to machine-readable text or structured data that encodes explanation information and constraint conditions, and is provided as input to a generative information processing model to control generation of output text.

The term “explanation information” refers to a combination of route information and attribute information, formatted for presentation to a user as guidance or descriptive content.

The term “constraint conditions regarding a speech style and a difficulty level” refers to parameters or descriptions that specify desired linguistic properties of generated text, such as sentence length, vocabulary complexity, tone, or degree of detail.

The term “generative information processing model” refers to a trained computational model that generates text or similar output data in response to input data, including but not limited to a generative AI model configured for language generation.

The term “summarized text” refers to text generated by the generative information processing model that is shorter and simpler than input explanation information while preserving essential content for user guidance.

The term “speech synthesis processing” refers to computational processing that converts text into acoustic data representing synthetic speech suitable for audio playback.

The term “guidance speech” refers to synthesized audio output that conveys navigation instructions, item explanations, or other assistance information to a user via an output device.

The term “output device” refers to any hardware component that presents guidance speech to a user, including but not limited to a speaker, headphone, earphone, or bone-conduction transducer.

The term “visually impaired person” refers to a user having a visual disability or limitation that reduces the user's ability to obtain information from visual displays.

The term “intellectually disabled person” refers to a user having a cognitive or intellectual disability that affects the user's ability to understand complex or abstract information, and who benefits from simplified and structured guidance.

In one embodiment, a server cooperates with a terminal operated by a user to provide audio guidance and item information within a physical facility such as a store, office, or public building. The terminal includes at least one microphone, at least one speaker or headphone interface, a display, and a wireless communication interface such as Wi-Fi or cellular. The server includes at least one processor, a memory, a network interface, and access to one or more storage devices storing facility layout data, item attribute data, and model configuration data.

The server uses a speech recognition engine, a generative AI model, and a speech synthesis engine to implement the claimed functions. In one concrete configuration, the server uses a cloud-based speech recognition service such as a generic cloud speech-to-text API, a transformer-based generative AI language model comparable to a large language model with multi-layer self-attention (for example, an architecture similar to GPT), and a neural text-to-speech engine such as a cloud-based speech synthesis API. The terminal executes a native application (for example, an application written in Kotlin on an Android device or in Swift on an iOS device) that records user speech, transmits audio data to the server, and plays back synthesized guidance speech.

The server stores facility layout data in a structured database, for example in a relational database such as PostgreSQL or a graph database such as Neo4j. The layout data represents nodes corresponding to sections, aisles, shelves, and reference points in the facility, and edges representing traversable paths between nodes. Each node includes coordinates, adjacency lists, and semantic labels (for example, “Entrance”, “Dairy Section”, “Cashier Area”). The server also stores item attribute data in a product catalog database, including item category identifiers, shelf locations (linked to layout nodes), pricing, volume, composition, and other attributes relevant to user guidance.

The server receives acoustic data from the terminal as digitized audio frames (for example, 16-bit linear PCM sampled at 16 kHz). The server sends this acoustic data to the speech recognition engine, which performs frame-wise feature extraction (for example, Mel-frequency cepstral coefficients, log-mel filter banks) and applies an acoustic model based on a deep neural network, such as a recurrent neural network or transformer encoder, followed by a language model to produce text hypotheses. The speech recognition engine outputs recognized text in the form of Unicode character strings and confidence scores.

The server analyzes the recognized text using a natural language understanding component. In one embodiment, the server uses a tokenization module, a part-of-speech tagger, and a named entity recognizer implemented with a neural sequence labeling model or with rule-based patterns. The server extracts a user intent (for example, “navigate_to_item”, “request_item_details”, “request_repetition”) and a target item category (for example, “milk”, “bread”, “cleaning tools”). The server resolves synonyms and variations by mapping tokens to canonical category identifiers using a dictionary stored in the catalog database.

The server associates the target item category with one or more section positions. The server queries the layout database to identify nodes corresponding to shelves or sections that store items belonging to the target category. The server retrieves position data for these nodes, including coordinates and adjacency relationships. The server then determines a user position, for example based on location data received from the terminal (such as Wi-Fi fingerprinting, Bluetooth beacon identifiers, or QR code positions) and maps the user position to a nearest layout node.

The server performs route computation on the layout graph using an algorithm such as Dijkstra's algorithm or A* search. The server uses edge weights that may represent distance, estimated walking time, or accessibility constraints. The server computes an optimal path from the user position node to the section position node. The server converts the resulting node sequence into route information, which may include step-level instructions such as “go straight for 10 meters”, “turn right at the second aisle”, and “the target shelf is to your left”. The server formats this route information as a structured internal representation, for example as a list of instruction objects, each containing a movement type, distance, directional cue, and semantic landmark label.

The server acquires attribute information relating to the target item from the product catalog database. The server retrieves, for example, item names, prices, packaging sizes, nutritional attributes, usage methods, and special characteristics such as “low fat” or “high calcium”. The server can select a subset of items that satisfy predetermined rules, such as “lowest price item”, “health-focused item”, or “popular item”. The server aggregates these attributes into a structured representation that includes key-value pairs and semantic tags.

The server generates explanation information by combining the route information and the attribute information. The server creates a representation that encodes: (i) the text-form instructions for moving from the user position to the section position, and (ii) a concise list of item descriptors to be communicated. The server then constructs a prompt sentence for the generative AI model. The prompt sentence is generated as plain text that includes explicit instructions to the model regarding speech style and difficulty level.

In one example, the server generates the following prompt sentence:
“You are a shopping assistant for a visually impaired user.
The user is at the store entrance and wants to find the milk section.
Route: go straight about 10 meters, then turn right at the second aisle, then continue about 5 meters; the milk shelf is on the left.
Available milk products:
1. Brand A milk, 1 liter, 200 yen, rich in calcium, low fat.
2. Brand B milk, 500 milliliters, 130 yen, standard fat.
Generate short, simple spoken instructions in English, suitable for a person with an intellectual disability.
First, explain how to walk from the entrance to the milk shelf.
Then, briefly describe the main features and price of the milk products.
Use short sentences and avoid difficult words.”

In another example, when the user stands in front of the shelf and requests more detail, the server generates the following prompt sentence:
“You are a supermarket assistant for a visually impaired user.
The user is standing in front of the milk shelf and wants to know more about low-fat milk.
Here is the product data:
Brand A low-fat milk, 1 liter, 210 yen, rich in calcium, low fat, best before 7 days.
Brand C extra low-fat milk, 1 liter, 230 yen, very low fat, best before 5 days.
Explain the differences in simple language.
Use short sentences.
Focus on fat content, price, and shelf life.
The explanation will be read aloud by a speech synthesizer, so avoid long or complex sentences.”

The server sends the constructed prompt sentence to the generative AI model. The generative AI model is implemented as a parameterized neural network with multiple transformer layers including self-attention, feed-forward sublayers, positional encoding, and layer normalization.

The model parameters have been trained in advance using supervised or self-supervised learning on large corpora of text. During training, the server or a training platform minimizes a loss function such as cross-entropy between predicted tokens and ground truth tokens, and updates model weights by backpropagation with an optimization algorithm such as Adam.

The model is further fine-tuned on domain-specific data including navigation instructions and item explanations aimed at accessibility use cases. Data augmentation techniques, such as synonym replacement and sentence simplification, can be used during training to strengthen the model's ability to generate short, plain-language descriptions.

The server configures the generative AI model at inference time with parameters such as temperature, maximum output length, and top-p sampling threshold. The server controls these parameters to enforce concise and stable output. The generative AI model receives the prompt sentence as a sequence of tokens and, at each decoding step, computes attention over previous tokens and internal representations to generate a probability distribution over next tokens. The server selects tokens according to the configured sampling strategy to build the summarized text. The server thus constrains the model through the structure of the prompt sentence and the decoding parameters so that the output meets the difficulty and style constraints.

The server receives the summarized text and post-processes it. The server segments the text into sentences, checks for length limits, and may perform additional rule-based adjustments, such as inserting pauses or repeating critical distance indicators. The server then forwards the summarized text to the speech synthesis engine. The speech synthesis engine implements a neural text-to-speech architecture, such as a sequence-to-sequence model with attention or a model based on convolutional and recurrent networks that predicts spectrogram frames, coupled with a vocoder model such as a WaveNet-type or similar autoregressive generator to produce waveform samples. The server converts the summarized text into acoustic data encoded as an audio file format (for example, MP3 or Ogg).

The terminal receives the synthesized audio from the server over a secure network connection. The terminal stores or directly streams the audio data into an audio playback pipeline provided by the operating system. The terminal plays the guidance speech to the user via the speaker or headphones. The user listens to the instructions and moves within the facility accordingly. The user can repeat the interaction by issuing further voice commands, without needing to see or interpret visual maps.

The server thereby performs not only a straightforward automation of human guidance but also an improvement in computer functioning. By integrating route computation, item attribute aggregation, prompt sentence generation, and controlled generative summarization into a single coordinated pipeline, the server avoids multiple redundant formatting and re-parsing steps that would occur if each function were implemented as an independent module.

Because the server encodes both route and attribute data into a single prompt sentence with explicit constraints, the generative AI model can produce a compact and coherent output that reduces the amount of text to be synthesized and the corresponding audio length. This reduction in length reduces processing time in the speech synthesis engine and decreases the communication load between the server and the terminal.

The server improves technical performance by structuring internal data as graph nodes and instruction objects for navigation, and as attribute key-value sets for items. This structure allows the server to generate explanation information in a canonical form that can be directly encoded into prompt sentences without intermediate free-form text compositions. As a result, the server reduces CPU usage and memory consumption, and improves cache efficiency when processing multiple user sessions concurrently. The explicit control of model parameters and prompt structure leads to predictable output lengths and complexity, which improves latency and avoids overload conditions in bandwidth-limited networks.

The server applies decision rules that differ from conventional human guidance strategies. For example, the server automatically groups route instructions into segments not exceeding a predetermined number of steps or a predetermined time duration, based on computational estimation of walking time and cognitive load. The server also selects only those item attributes that match predefined feature sets (such as price, volume, key nutritional tag) encoded as machine-readable feature vectors. These rules are implemented algorithmically and do not simply mimic human narrative behavior. The server uses these rules to create feature representations that are used as part of the prompt sentence, which in turn constrains the generative AI model to focus on relevant technical information.

The server can operate in multiple embodiments. In one embodiment, the server executes all recognition, route computation, generative summarization, and synthesis in a single cloud instance. In another embodiment, the server decomposes these functions into microservices, with one microservice dedicated to speech recognition, one to navigation and layout computation, one to prompt construction and generative AI inference, and one to speech synthesis. In a further embodiment, some processing components, such as preliminary text simplification or local caching of summarized texts, may execute on the terminal to reduce round-trip time.

The server may use alternative algorithms for route computation, such as dynamic programming-based path selection that weighs accessibility constraints or crowd density estimates. The server may also use alternative generative AI models, such as encoder-decoder architectures or models with specialized heads for summarization tasks. The server may adjust error functions and training regimes, for example by adding penalty terms to the loss function for overly long or syntactically complex sentences, thereby biasing the model toward simpler outputs. The server may incorporate additional features, such as automatic detection of user comprehension difficulties based on repeated queries, and may adapt prompt sentences accordingly by further reducing sentence length or repeating key information.

The server thus provides a concrete, technical implementation that leverages specific data structures, neural network architectures, and coordinated processing steps to improve computation efficiency, latency, and robustness when delivering navigation and item guidance to visually impaired users and intellectually disabled users. The system does not merely perform generic data acquisition, analysis, and display, but instead implements a specialized pipeline that restructures internal data, controls generative model behavior through prompt sentences and decoding parameters, and reduces hardware resource usage while improving accuracy and suitability of audio guidance in real-world environments.

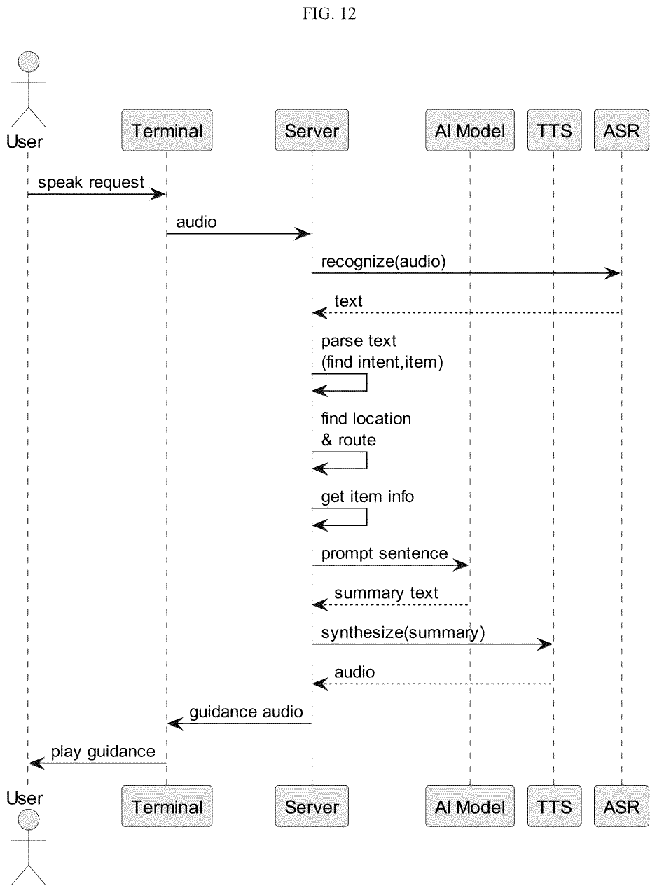

The following describes the processing flow using FIG. 12.

Step 1:
The user launches an accessibility guidance application on the terminal and initiates a voice interaction.
The terminal activates a microphone, acquires raw audio frames of the user's speech (input: analog voice signal; output: digitized acoustic data such as 16-bit PCM samples), and buffers the acoustic data in memory. The terminal further attaches session identifiers and environment metadata to the buffered data.

Step 2:
The terminal sends the buffered acoustic data to the server over a network connection.
The terminal packages the acoustic data and metadata into a request message (input: digitized acoustic data and session metadata; output: a structured network packet such as an HTTPS request) and transmits the packet through a wireless interface. The terminal thereby performs data encapsulation and error-checking operations before sending.

Step 3:
The server receives the request and extracts the acoustic data for recognition.
The server parses the network packet (input: HTTP request containing acoustic data and metadata; output: raw acoustic data buffer and associated session parameters) using a web framework. The server validates headers, verifies authentication tokens, and stores the acoustic data in volatile memory for further processing.

Step 4:
The server performs speech recognition processing on the acoustic data to obtain character string data.
The server forwards the acoustic data to a speech recognition engine (input: digitized acoustic data; output: recognized text and confidence scores). The speech recognition engine computes acoustic features (for example, log-mel filter bank features) and applies a neural acoustic model and language model to generate text hypotheses. The server selects the highest-confidence hypothesis and stores the resulting character string data in a session record.

Step 5:
The server analyzes the character string data to identify the user's request content and target item.
The server tokenizes and parses the recognized text (input: character string data; output: structured intent and item category identifier). The server applies a natural language understanding algorithm that includes word segmentation, part-of-speech tagging, and rule-based or neural entity extraction. Based on this analysis, the server determines whether the request is, for example, “navigate to item” or “explain item details,” and maps extracted item names or phrases to canonical item categories stored in a catalog database.

Step 6:
The server determines a section position corresponding to the target item and associates it with the user's current position.
The server queries a layout database (input: item category identifier and facility identifier; output: one or more section positions represented as graph nodes or coordinates). The server then maps the user's approximate position, received as part of the request metadata or from a separate location service, to a start node in the layout graph. The server stores both the start node and the target section node in the session context.

Step 7:
The server calculates a route within the facility between the user position and the section position and generates route information.
The server applies a path-finding algorithm on the layout graph (input: start node and target node; output: a sequence of nodes or waypoints forming an optimal route). The server computes edge costs such as distance or estimated time and determines the minimum-cost path. The server then converts the path into step-by-step route information by generating human-readable instructions like “go straight 10 meters” or “turn right at the second aisle” and stores these as structured instruction objects.

Step 8:
The server retrieves attribute information for the target item from an information storage unit.
The server issues a query against a product catalog or item database (input: item category identifier and facility identifier; output: a set of attribute records for items in the category).
The server extracts fields such as item name, price, size, composition, usage method, and special characteristics. The server applies selection rules to reduce the set of items to a manageable number, and constructs attribute information structures formatted as key-value pairs for each selected item.

Step 9:
The server generates explanation information by combining the route information and the attribute information.
The server merges the structured route instructions with the selected item attribute structures (input: route information objects and item attribute objects; output: a combined explanation information object). The server arranges route steps and item descriptions in a logical order and embeds semantic tags indicating importance or priority. The resulting explanation information is stored in memory as an internal data structure suitable for text generation.

Step 10:
The server constructs a prompt sentence for a generative AI model based on the explanation information and constraint conditions.
The server formats the explanation information into plain-language text segments and appends explicit instructions describing the desired speech style and difficulty level (input: explanation information object and style/difficulty parameters; output: a single prompt sentence or prompt text block). The server, for example, generates a prompt sentence such as: “You are a shopping assistant for a visually impaired user.
The user is at the store entrance and wants to find the milk section.
Route: go straight about 10 meters, then turn right at the second aisle, then continue about 5 meters; the milk shelf is on the left.
Available milk products:
1. Brand A milk, 1 liter, 200 yen, rich in calcium, low fat.
2. Brand B milk, 500 milliliters, 130 yen, standard fat.
Generate short, simple spoken instructions in English, suitable for a person with an intellectual disability.
First, explain how to walk from the entrance to the milk shelf.
Then, briefly describe the main features and price of the milk products.
Use short sentences and avoid difficult words.”

Step 11:
The server inputs the prompt sentence to the generative AI model and obtains summarized text tailored to the user.
The server sends the prompt text to a transformer-based language model (input: prompt sentence and decoding parameters; output: summarized guidance text). The generative AI model encodes the prompt into internal vectors, applies self-attention across tokens, and decodes a sequence of output tokens according to configured parameters such as temperature and maximum length. The server concatenates the generated tokens into natural-language text and stores the summarized text in the session record.

Step 12:
The server performs post-processing on the summarized text to ensure suitability for speech output.
The server segments the text into sentences, checks sentence length and vocabulary complexity (input: raw summarized text from the generative AI model; output: cleaned and segmented guidance text). The server may insert additional delimiters or repetition for critical navigation instructions and remove extraneous phrases. The server thereby produces a final guidance text that satisfies predefined linguistic constraints.

Step 13:
The server converts the final guidance text into acoustic data using a speech synthesis engine.
The server submits the text to a neural text-to-speech system (input: final guidance text; output: synthesized audio data in a specific audio format). The speech synthesis engine converts the text into a sequence of acoustic features and generates a waveform using a neural vocoder. The server encodes the waveform into a compressed audio file and associates the resulting file with the current user session.

Step 14:
The server transmits the synthesized acoustic data to the terminal for playback.
The server embeds the audio file and optional metadata such as a text transcript into a response message (input: synthesized audio data and session identifier; output: network response packet) and sends it via a secure communication channel. The server updates the session state to reflect that the guidance corresponding to the detected request has been delivered.

Step 15:
The terminal receives the synthesized acoustic data and prepares it for output.
The terminal parses the response packet (input: network response from the server; output: local audio buffer and optional text transcript) and verifies integrity and format. The terminal configures an audio playback pipeline with appropriate sampling rate and volume and loads the audio buffer into the playback module.

Step 16:
The terminal plays the guidance speech to the user through an output device.
The terminal drives a speaker or connected headphones to output the synthesized audio (input: audio buffer ready for playback; output: audible guidance speech perceived by the user). The terminal optionally displays a minimal textual or symbolic indication synchronized with the audio. The user listens to the instructions and moves within the facility or interacts with items based on the content of the guidance speech.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information presentation systems that convert text into speech typically operate as linear pipelines: a document is converted to text, optionally summarized by fixed heuristic rules, and then synthesized into audio with static voice parameters. Such systems are limited in several respects. First, they lack flexible, context-aware transformation of document content; rule-based summarization and formatting engines are not well suited to complex or heterogeneous documents such as meeting agendas, work procedures, or usage instructions for tools that are rarely used. Second, these systems generally do not leverage advanced generative models that can dynamically rewrite technical content into forms that are easier to understand for users with visual or cognitive impairments. As a result, the generated audio often preserves the complexity and structure of the original document, which can overburden users with limited memory, comprehension, or attention.

Third, existing architectures typically do not integrate user attribute information and user state information (for example, whether a user has a visual impairment or a cognitive impairment, or whether the user is currently under stress or fatigue) into the end-to-end processing pipeline. The audio output conditions (such as content selection, level of detail, ordering, and speech rate) are usually fixed or manually configured by the user at playback time, and are not automatically adapted by the server computation. This leads to inefficiency in the use of computing resources, because the same unadapted audio must be repeatedly generated or manually navigated, and reduces the effectiveness of the system for accessibility support.

Furthermore, conventional client-server systems do not provide a standardized mechanism for generating prompt sentences for a generative AI model on the basis of both structured information extracted from documents and user-specific configuration. Prompt construction is often delegated to ad-hoc application code or to the end user, resulting in inconsistent quality of generated explanations, non-deterministic behavior, and difficulty in scaling across many types of documents and users. From the perspective of computer technology, there is a need for a server-side processing architecture that (i) systematically converts unstructured electronic information into structured representations, (ii) automatically constructs prompt sentences for generative models using that structured information and user-specific parameters, and (iii) transforms the generative output into audio in a way that is adaptively controlled by machine-interpretable user attribute and state information.

Accordingly, there is a demand for an improved computer-implemented system that integrates document analysis, structured representation generation, prompt-based generative processing, and adaptive audio synthesis in a unified processing flow on a processor. Such a system should improve the functioning of the server by reducing manual configuration, automating the adaptation of content and audio output to user characteristics, and efficiently utilizing generative AI models to produce explanation information that is specifically optimized for audio consumption by users with visual or cognitive impairments.

The specific processing by the specific processing unit 290 of the data processing device 12 in Example 2 is realized by the following means.

The present invention provides a server comprising a processor configured to obtain electronic information from a user via a communication interface, analyze the electronic information to extract character information and convert the character information into structured information, generate an instruction sentence to be input to a generative information processing model on the basis of the structured information and instruction information given by the user, input the instruction sentence and the structured information into the generative information processing model to cause the generative information processing model to generate explanation information, convert the explanation information into audio information, transmit the audio information to an output apparatus, and adjust a content of the explanation information or an output condition of the audio information on the basis of attribute information and state information of a user having an impairment in visual function or a user having an impairment in cognitive function. This enables the server to implement an improved, computer-centric processing pipeline in which unstructured documents such as meeting schedules and work procedures are transformed into structured data, automatically translated into adaptive prompt sentences for a generative AI model, converted into tailored explanation information, and synthesized into audio that is dynamically optimized for the specific impairments and real-time state of the user, thereby improving the technical performance and usability of the information presentation system.

The term “electronic information” refers to data representing characters, symbols, images, or other content stored or transmitted in a digital format and capable of being processed by an information processing apparatus.

The term “character information” refers to textual data obtained from electronic information, including letters, numerals, symbols, and punctuation that can be interpreted as a sequence of characters.

The term “structured information” refers to information represented in a machine-interpretable format in which elements of character information are organized according to a predetermined schema, such as a list, table, or object structure associating items with attributes including time, title, and description.

The term “instruction information” refers to information indicating a user's preference, intention, or operation mode, including options such as summarization level, target user type, level of detail, and style of explanation to be applied to processing of the electronic information.

The term “instruction sentence” refers to a sequence of characters including an explicit or implicit directive that specifies how a generative information processing model is to process given information, and that is formatted as a natural language or machine language input to the generative information processing model.

The term “generative information processing model” refers to a computation model, such as a parameterized machine learning model, configured to generate new information including text or other data in response to input information, the generation being based on statistical patterns learned from training data.

The term “explanation information” refers to information generated by the generative information processing model that explains, summarizes, restructures, or otherwise describes the content of the electronic information in a form suitable for presentation to a user.

The term “audio information” refers to data representing sound, including encoded or unencoded waveforms, that is suitable for reproduction as audible output by an output apparatus.

The term “output apparatus” refers to a device configured to receive audio information from a server or other information processing apparatus and to output the audio information as sound, including a terminal device comprising a loudspeaker or a headphone interface.

The term “attribute information” refers to information representing characteristics of a user, including at least a type of impairment, a language preference, a proficiency level, or other static or semi-static user properties that affect how information is to be presented.

The term “state information” refers to information representing a current or recent condition of a user, including factors such as attention level, fatigue level, stress level, or interaction history, which may be used to adjust content or output conditions.

The term “impairment in visual function” refers to a condition of a user in which the user's capability to visually recognize character information is limited or degraded, such that conventional text-based interfaces are difficult to use.

The term “impairment in cognitive function” refers to a condition of a user in which the user's capability to understand, memorize, or process complex information is limited or degraded, such that simplification or stepwise explanation is beneficial.

The term “progress schedule information of a meeting” refers to information indicating a temporal sequence of agenda items, including at least a time associated with each item and a description of the item, for a planned meeting or similar event.

The term “work procedure information” refers to information describing steps, operations, or tasks to be performed in a process, including at least an order of actions and corresponding descriptions, for execution by a user.

The term “time information” refers to information indicating a temporal point or interval, such as a clock time, date, or duration, that can be associated with an event, step, or agenda item.

The term “item information” refers to information representing a unit element within a document, such as an agenda entry, step description, heading, or bullet point, that can be individually identified and manipulated.

The term “colloquial form” refers to a style of text that approximates natural spoken language, including simplified sentence structure, explicit connective expressions, and phrasing suitable to be read aloud.

The term “use procedure information of a low-frequency-use tool” refers to information describing steps for operating a device or tool that is not used regularly by a user, the steps including preparation, operation, and termination procedures.

The term “matters that are difficult to memorize” refers to information that users tend to forget, such as infrequently used procedures, codes, or multi-step instructions, for which repeated or simplified explanation is beneficial.

The term “short sentences” refers to sentences having a limited length, constrained by a predetermined number of words, characters, or clauses, and configured to be easily understood when heard once.

The term “stepwise” refers to a presentation format in which explanation information is divided into discrete, ordered units, each unit describing a single action or concept, and arranged in a sequence that indicates a progression.

In one embodiment, a server includes a processor, a main memory, a non-volatile storage device, a network interface, and an audio output interface, all interconnected by a system bus. The server executes an operating system such as a general-purpose server operating system, and executes application software implementing the processing described herein. The server communicates with a terminal via a network such as a local area network or a wide area network, and the terminal is operated by a user.

The terminal includes a processor, a memory, a display device, an input device, an audio output device such as a loudspeaker or headphones, and a communication interface. The terminal executes an application such as a web browser or a native client program. The user uses the terminal to select and upload electronic information such as a meeting agenda document or work procedure document to the server.

The server stores received electronic information in a storage subsystem such as a relational database management system and a file storage system. For example, the server uses a structured storage to store metadata (user identifier, upload time, document type) and uses a file system or object storage to store binary data of the electronic information. The server identifies the format of the electronic information (for example, plain text, markup language document, document file, or digital image file containing text) and uses an appropriate parsing component to extract character information. The server may use a text extraction library for text-based document formats and an optical character recognition engine for image-based documents. The server normalizes extracted character information by applying character set conversion, whitespace normalization, and segmentation into tokens and sentences.

The server converts the normalized character information into structured information. The server uses a text analysis component that applies tokenization, sentence boundary detection, part-of-speech tagging, and rule-based pattern recognition to identify time information, item information, headings, and list structures. The server represents the structured information in a data structure such as an array of records, each record including fields for time information, item title, and item description. The server stores this structured information in the database and maintains an association between the structured information and the original electronic information.

The server generates an instruction information data structure based on preferences received from the user through the terminal and based on attribute information and state information associated with the user. For example, the server stores in the database, for each user, an indication of whether the user has an impairment in visual function or an impairment in cognitive function, a preferred language, a preferred level of detail, and a maximum sentence length. The server also stores state information such as interaction history, number of replays of certain items, and optional external sensor measurements. The server merges these data into a configuration object that guides further processing.

The server constructs a prompt sentence for a generative AI model using both the structured information and the instruction information. The server uses a deterministic template engine that inserts structured fields into a predefined natural-language template. For example, when the user is a visually impaired user, the server constructs a prompt sentence such as:
“Rewrite the following meeting agenda in clear, spoken-style language suitable to be read aloud for a visually impaired user. Keep the structure chronological and insert short pauses between items. Agenda: 10:00 Opening remarks; 10:15 Project progress report; 11:00 Break.”
When the user is a user with an impairment in cognitive function, the server constructs a prompt sentence such as:
“Explain the following tool usage instructions in very simple, short sentences, step by step, for a user with cognitive impairment. Limit each sentence to at most 15 words and number each step. Instructions: [original procedure text].”

By using structured information rather than raw text, the server places time information and item information into explicit lists and uses these lists to generate prompts that are consistent and machine-verifiable. This reduces ambiguity in the prompt and improves reproducibility of output across documents and users.

The server inputs the constructed prompt sentence and at least part of the structured information into a generative AI model deployed on a compute platform. In one embodiment, the generative AI model is a transformer-based neural network trained for language modeling.

The model includes an embedding layer that maps tokens to dense vectors, a stack of self-attention layers with multi-head attention, layer normalization, and feed-forward sublayers, and an output layer that maps hidden states back to token probabilities. The model is trained using a cross-entropy loss function on large-scale text corpora, and its parameters (weights) are updated by a gradient-based optimization algorithm such as Adam. During inference, the server encodes the prompt sentence into token identifiers, feeds them into the model, and generates explanation information by iterative decoding, for example using beam search or top-k sampling with a temperature parameter.

The server configures the decoding parameters of the generative AI model based on attribute information and state information. For example, when the user has an impairment in cognitive function, the server sets a lower temperature and smaller beam width to obtain less diverse and more conservative outputs, thereby reducing confusion. When the user's state information indicates repeated playback of earlier items, the server biases generation toward more explicit repetition and inserted summaries. The server uses structured information to constrain generation: for example, the server appends a machine-readable delimiter and time tags into the prompt so that the model tends to generate explanations aligned with each time slot. This alignment improves downstream mapping between explanation segments and audio segments, and allows the server to more efficiently control partial playback on the terminal.

The server post-processes explanation information generated by the generative AI model. The server parses the generated text to detect numbered steps, headings, and paragraph boundaries. The server enforces constraints such as maximum sentence length by splitting overly long sentences at punctuation boundaries and inserting connective phrases. The server also maps generated segments back to the structured information records, so that each agenda item or work step is associated with a segment of explanation information. This mapping is stored in the database as an index structure, allowing random access during audio playback.

The server converts the explanation information into audio information using a text-to-speech engine. The server may use a neural text-to-speech system that includes an encoder-decoder architecture with attention, where the encoder converts text tokens into a sequence of hidden representations, and the decoder generates a spectrogram representation of audio, followed by a vocoder component that converts the spectrogram into a waveform. During synthesis, the server supplies prosody control parameters derived from attribute information and state information, such as slower speaking rate and increased pause duration for users with cognitive impairments, or increased volume emphasis on time information for users with visual impairments. The server generates audio segments corresponding to each explanation segment, and stores them as audio files in compressed format along with metadata such as duration, text hash, and user profile identifier.

The server transmits the audio information to the terminal over the network. The server may stream audio data using a streaming protocol or provide a reference to an audio resource that the terminal retrieves on demand. The server may group multiple short audio segments into a playlist structure to minimize connection overhead and to reduce communication load.

Because the server generates audio at the segment level, the terminal can request only required segments rather than downloading an entire long file, which reduces bandwidth usage and latency for the user.

The terminal receives audio information and plays it through the audio output device. The terminal uses an operating system media subsystem to decode the audio and render it. The terminal presents user interface controls such as “next item,” “previous item,” and “repeat step.” The terminal can send feedback to the server indicating which segments are frequently repeated or skipped. The server updates state information in the database based on this feedback and adjusts future prompt sentences and audio synthesis parameters. For example, if the user repeatedly replays certain steps, the server modifies subsequent explanations to include simpler phrasing or additional intermediate steps.

The user interacts with the system by selecting documents, choosing processing options, and controlling playback. The user may indicate preferences such as “summarize only key points,” “include all details,” or “slow speech.” The terminal encodes these preferences as instruction information and transmits them to the server. The server integrates these preferences into the configuration object used during prompt sentence generation and TTS parameter selection.

From a computer-technology standpoint, the server improves functioning of the overall system beyond mere automation of human reading and summarization. The server uses a structured intermediate representation that is specifically designed for programmatic manipulation of schedule and procedure documents. This representation allows the server to perform selective transformation, alignment, and caching at the level of individual items, thereby enabling incremental updates when only part of a document changes. As a result, when a user uploads a revised agenda or procedure, the server reuses previously generated explanation information and audio segments for unchanged items, and generates new outputs only for modified items. This reduces processing time, reduces load on the generative AI model, and decreases network traffic for the terminal.

The server also employs non-conventional prompt construction logic. Instead of simply concatenating user text and a generic request, the server uses structured information and user attributes to build prompts that include explicit structural cues, such as explicit numbering, time tags, and prose constraints, in a consistent format. This structured prompt construction leads to more stable and predictable behavior of the generative AI model, reducing the need for repeated trial-and-error human prompt engineering. As a result, the server reduces variance in output quality and decreases computational cost because fewer regeneration attempts are required.

In another embodiment, the server uses a fine-tuned generative AI model trained specifically on schedule documents and procedure manuals. The server prepares a training dataset by pairing original structured information and instruction information with desired explanation information. The server trains the model using supervised learning, applying a loss function such as cross-entropy between predicted tokens and ground truth tokens. The server performs weight updates with a stochastic gradient-based optimizer and applies regularization techniques such as dropout and label smoothing. The server may perform data augmentation by shuffling non-dependent items, paraphrasing steps, and injecting noise into timings, which increases the robustness of the model. By customizing the generative AI model to this particular task and data structure, the server improves generation accuracy and consistency, which in turn reduces post-processing corrections and audio regeneration.

In a further embodiment, the server pre-computes and caches embeddings of common phrases, agenda patterns, and procedure templates using the embedding layer of the generative AI model or a separate embedding model. The server stores these embeddings in a vector index structure. When the server receives new electronic information, the server computes embeddings of its structured information and quickly retrieves similar patterns from the index. The server then selects corresponding prompt patterns and explanation templates that are known to yield high quality results. This retrieval-and-generation combination reduces generation time and improves relevance of explanations. The use of vector indexing constitutes a concrete data structure that improves computational efficiency and is not merely a business rule abstraction.

Another embodiment uses different types of generative AI models. The server may deploy a smaller, on-premise generative AI model for latency-sensitive use cases and may call a larger, remote model for documents requiring higher quality or complex reasoning. The server dynamically selects the model based on document length, complexity metrics computed from structured information, and current system load. By doing so, the server balances processing speed and resource utilization, achieving an overall reduction in average response time and avoiding network congestion.

Because the server uses attribute information and state information to modify not only output content but also algorithmic behavior (such as decoding parameters, template selection, and model selection), the system exhibits an adaptive computational pattern that is different from static, rule-based summarization. This adaptation leads to technical effects: reduction of repeated network transfers (due to targeted segment playback), improvement of comprehension-related metrics (such as fewer replays per item), and reduction of server CPU and memory usage by avoiding unnecessary full-document regeneration.

Alternative embodiments may use different neural network architectures, such as recurrent neural networks or convolutional sequence models, instead of transformers, or may integrate external knowledge bases that supply definitions or explanations for technical terms. In such embodiments, the server uses the same structured information and instruction information data structures but changes the internal generative architecture and training procedure. The server may also modify the loss function to include additional terms that penalize overly long sentences or encourage explicit numbering, which directly encodes the accessibility requirements into the training objective.

In yet another embodiment, the server performs on-device adaptation by sending lightweight rule sets or small adapter modules to the terminal. The terminal then locally modifies playback order, pauses, and repetition frequency based on user interaction. The server collects logs of these local behaviors and uses them to refine future prompt sentences and to retrain or fine-tune the generative AI model. This feedback loop creates a technical cycle in which model behavior and system configuration are continuously optimized based on real usage patterns, leading to improved performance over time.

By organizing processing around clearly defined data structures (electronic information, character information, structured information, instruction information, attribute information, state information, explanation information, and audio information), by using specific generative model architectures and training procedures, and by implementing non-conventional prompt sentence construction and adaptive synthesis, the server, terminal, and user interaction form a system that provides technical improvements in computation speed, audio output relevance, bandwidth usage, and accessibility effectiveness, while enabling others skilled in the art to implement the invention based on the detailed description above.

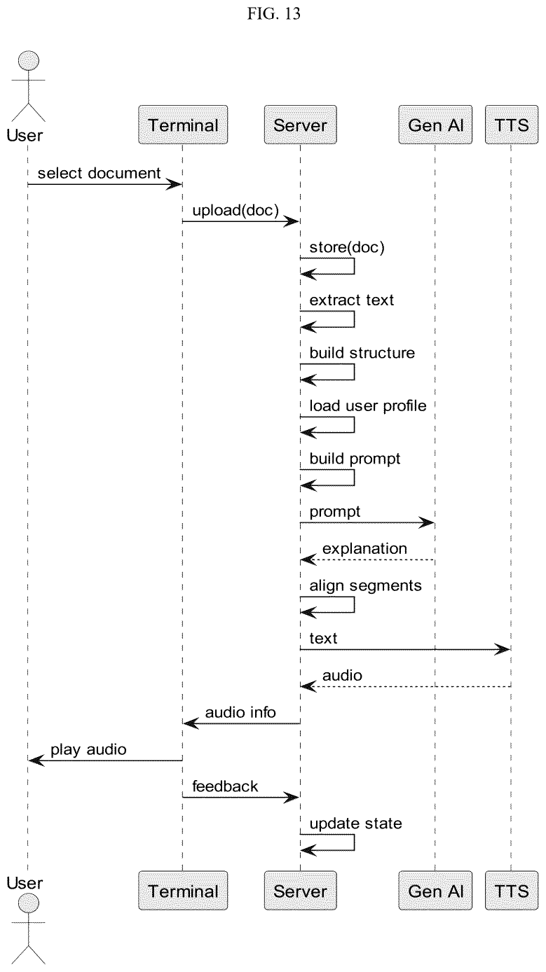

The following describes the processing flow using FIG. 13.

Step 1:
The user prepares electronic information.
The user operates the terminal to create or select electronic information, such as a meeting agenda document or a work procedure document. The input of this step is human-readable content, for example a text file, a document file, or an image containing printed text. The user may edit the content on the terminal using an editor application and store it in the terminal's local storage. The output of this step is a stored electronic file that can be selected for upload.

Step 2:
The terminal sends the electronic information to the server.
The terminal receives a selection command from the user and reads the corresponding file from local storage as binary data. The input of this step is the electronic file and basic metadata such as file name and type. The terminal encapsulates the binary data and metadata into a network request message and transmits the message to the server over a network using a communication protocol. The output of this step is an incoming request at the server containing the electronic information.

Step 3:
The server stores the electronic information and associated metadata.
The server receives the request through its network interface and extracts the binary file data and metadata from the request body. The input of this step is the uploaded binary data and metadata (user identifier, file type, timestamp). The server writes the binary data to a storage system and creates a database record containing a file identifier, the user identifier, the file type, and the storage location. The output of this step is a persistent association between the user and the stored electronic information.

Step 4:
The server extracts character information from the electronic information.
The server loads the stored file based on the file identifier and examines the file type. The input of this step is the stored file path and the file type. The server selects an appropriate parser: for text-based formats, the server decodes the bytes into a character string; for formatted document files, the server calls a parsing library to extract visible text; for images, the server calls an optical character recognition engine to detect characters. The server concatenates and normalizes the detected characters into a unified character string. The output of this step is character information representing the content of the electronic information.

Step 5:
The server normalizes and segments the character information.
The server takes the raw character string as input. The input of this step is the unstructured character information. The server converts character encodings if necessary, removes extraneous whitespace, and standardizes line breaks. The server applies tokenization and sentence boundary detection to segment the text into tokens and sentences. The server may also apply basic corrections, such as joining broken lines of a single logical sentence. The output of this step is a normalized and segmented character sequence that is suitable for further analysis.

Step 6:
The server generates structured information from the normalized character information.
The server analyzes the normalized text using linguistic rules and pattern matching. The input of this step is the normalized, segmented character data. The server searches for patterns that indicate time information (for example, “10:00”, “11:00”, or “09:30”) and associates these with nearby sentences to form item information. The server detects headings, bullet points, and numbering, and groups related lines into items representing agenda entries or procedure steps. The server organizes these items into a data structure such as a list of records, where each record includes fields for time, title, and description. The output of this step is structured information that explicitly encodes the logical elements of the document.

Step 7:
The server obtains attribute information and state information for the user.
The server queries a user profile store using the user identifier linked to the uploaded document. The input of this step is the user identifier. The server reads stored attributes such as presence of visual impairment, presence of cognitive impairment, language preference, and preferred detail level. The server also reads state information such as historical replay frequency and previous interaction patterns. The server may update some of these values based on the current session. The output of this step is an attribute and state information set that describes how the content should be adapted for the user.

Step 8:
The server generates instruction information for downstream processing.
The server combines the structured information with the attribute and state information. The input of this step is the structured information and the user's attribute and state information.
The server determines parameters such as target complexity level, maximum sentence length, whether to number steps, and required language. The server writes these parameters into an internal configuration structure. The output of this step is instruction information that specifies how explanation information should be produced for this user and this document.

Step 9:
The server constructs a prompt sentence for the generative AI model.
The server applies a template-based prompt generation algorithm. The input of this step is the structured information and the instruction information. The server inserts fields such as time information and item information into a sentence template and includes instructions derived from user attributes, such as “use simple short sentences” or “explain for a visually impaired user.” For example, for a visually impaired user, the server may generate a prompt sentence:
“Rewrite the following meeting agenda in clear, spoken-style language suitable to be read aloud for a visually impaired user. Keep the structure chronological and insert short pauses between items. Agenda: 10:00 Opening remarks; 10:15 Project progress report; 11:00 Break.”
The output of this step is a complete prompt sentence that describes the required behavior of the generative AI model and embeds the structured content.

Step 10:
The server calls the generative AI model to generate explanation information.
The server tokenizes the prompt sentence and passes the tokens to a generative AI model executing on a compute platform. The input of this step is the prompt sentence and optionally an encoding of the structured information. The generative AI model, implemented as a neural network, computes hidden representations and outputs token probabilities step by step to form new text. The server decodes the output tokens into characters and assembles them into explanation text. The server may control decoding parameters, such as maximum length and randomness level, based on the instruction information. The output of this step is explanation information: a text that explains or reformats the original document content for the user.

Step 11:
The server post-processes the explanation information and aligns it with the structured information.
The server receives the generated explanation text as input. The input of this step is the explanation information. The server parses the explanation text to identify segments corresponding to each agenda item or procedure step, using cues such as numbering or time references. The server enforces constraints from the instruction information, such as splitting long sentences or adding explicit numbering if missing. The server then maps each explanation segment to the corresponding record in the structured information and stores these mappings. The output of this step is a set of aligned explanation segments that can be individually addressed and reproduced.

Step 12:
The server converts the aligned explanation information into audio information.
The server selects a text-to-speech engine and configures synthesis parameters. The input of this step is the aligned explanation segments and the user's attribute and state information.
The server passes each explanation segment to the text-to-speech engine with parameters such as speech rate, pitch, and pause duration tuned for the user's impairment type. The text-to-speech engine performs signal processing and generates audio waveforms or compressed audio files. The server stores each audio segment with identifiers matching the corresponding explanation segment. The output of this step is a set of audio information segments ready for transmission.

Step 13:
The server prepares and transmits audio information to the terminal.
The server creates references (such as URLs or identifiers) to the generated audio segments and compiles them into a playback sequence. The input of this step is the stored audio segments and their identifiers. The server responds to a terminal request by transmitting audio data directly or by sending references that the terminal can use to retrieve audio segments on demand. The server may group several contiguous segments into a batch to reduce communication overhead. The output of this step is audio data or audio references delivered to the terminal.

Step 14:
The terminal receives the audio information and manages playback.
The terminal obtains the audio data or references from the server. The input of this step is the transmitted audio information or references. The terminal downloads required audio segments, decodes them if necessary, and loads them into a media playback component. The terminal maintains a mapping between user interface controls and the segment identifiers so that actions such as “next item” or “repeat step” can be resolved. The output of this step is a prepared playback state in which audio segments are available for output.

Step 15:
The terminal outputs audio to the user and collects interaction feedback.
The terminal receives playback commands from the user, such as play, pause, next, or previous. The input of this step is the user's control operations and the prepared playback state. The terminal sends audio samples to the audio output device according to the selected segment and adjusts volume using system settings. The terminal also records interaction events, such as repeated playback of specific segments or early skipping. The output of this step is audible sound presented to the user and a log of interaction data.

Step 16:
The server updates state information based on terminal feedback.
The server receives interaction logs from the terminal at the end of a session or periodically.
The input of this step is the feedback data indicating segment usage patterns. The server aggregates counts of replays, skips, and interruptions and updates the user's state information in the database. The server uses these updated values to adjust future instruction information, for example by simplifying frequently replayed segments or slowing down speech for certain types of content. The output of this step is a refined state profile that will influence subsequent prompt sentences and audio generation, thereby closing the adaptive loop of the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional assistive systems that convert spoken input into audio guidance for users with visual or cognitive limitations generally implement a fixed pipeline of speech recognition, static text retrieval, and text-to-speech. Such systems typically output preauthored messages or template-based descriptions that do not adapt to the user's current context, level of understanding, or emotional state. As a result, these systems often produce audio guidance that is either too technical, too condensed, or too verbose, and they lack the ability to dynamically rewrite and personalize explanations in real time.

Furthermore, existing systems usually handle visual codes such as optical codes or wireless tags independently from voice-based interaction. When a user scans a code attached to a product, tool, or document, the system frequently returns raw catalog data or unprocessed document text, without semantically restructuring the information into stepwise instructions or summarized explanations suited for spoken delivery. This leads to cognitive overload and prevents users with disabilities from effectively understanding complex procedures, product characteristics, or schedule information.

In addition, emotion handling in known systems is typically limited to coarse event logging or simple volume changes. Conventional architectures rarely integrate emotion recognition tightly with the generation and adjustment of explanation content. In particular, they do not leverage generative AI models with explicit prompt sentences to (i) infer the user's emotional state from speech or other interaction data, and (ii) rewrite explanation text so that linguistic difficulty, information density, repetition frequency, and prosody control are all coordinated in response to the detected emotion. Consequently, when a user is confused, anxious, or frustrated, existing systems cannot systematically reduce linguistic complexity, increase repetition, or adjust speaking style in a consistent, machine-controllable way.

From a computer-technology perspective, conventional systems generally treat speech recognition, content retrieval, natural language generation, emotion analysis, and speech synthesis as isolated modules, with minimal shared state and no unified representation of prompts, explanation text, and emotion metadata. This fragmented architecture makes it difficult to optimize processing pipelines, reuse historical interaction data, or adapt model behavior across sessions. It also prevents the system from efficiently reusing previously generated prompts and responses to reduce computation load and network traffic when similar queries recur.

Accordingly, there is a need for an improved computer-implemented system that (i) jointly handles voice input and code-based input as unified interaction events, (ii) employs a generative AI model driven by explicit prompt sentences to generate and iteratively rewrite explanation text, (iii) tightly integrates emotion recognition into both language generation and speech synthesis parameter control, and (iv) maintains an interaction history linking prompts, explanation text, and emotional state in a manner that improves the efficiency, responsiveness, and adaptability of the overall computing system. By addressing these limitations, the invention aims to improve the functioning of the underlying computer system itself, rather than merely automating a mental process, through coordinated control of model prompts, text transformation, and audio output based on real-time user feedback and emotional state.

The specific processing by the specific processing unit 290 of the data processing device 12 in Application Example 2 is realized by the following means.

The present invention provides a server comprising at least one processor and at least one memory storing instructions that, when executed by the at least one processor, cause the server to receive user input including at least one of voice input and code information, convert the voice input into text data and acquire target information from an information storage device based on an identification code obtained from at least one of an optical code and a wireless tag, construct a prompt sentence for a generative AI model based on at least one of the text data and the target information in accordance with at least one of a user attribute and a usage situation, input the prompt sentence and at least one of the text data and the target information into the generative AI model so as to cause the generative AI model to generate explanation text, input at least one of an emotion analysis prompt sentence relating to the explanation text and analysis target information relating to at least one of user utterance and user expression into at least one of the generative AI model and an emotion analysis device to identify a user emotional state, dynamically rewrite the explanation text by using the generative AI model, on the basis of the explanation text and the emotional state, so as to convert the explanation text into adjusted text by changing at least one of linguistic difficulty, amount of information, and number of repetitions, input the adjusted text into a speech synthesis device to generate audio data while controlling audio parameters including at least one of speaking rate, pitch, and prosody in accordance with the emotional state, and store the explanation text, the prompt sentence, and the emotional state in association with one another for reuse in subsequent generation of explanation text and subsequent adjustment of audio output. This enables an improvement in computer functionality by providing a unified, stateful processing architecture in which generative AI prompting, emotion-aware text transformation, and adaptive speech synthesis are tightly integrated, thereby allowing the server to automatically tailor the form, complexity, and delivery characteristics of audio guidance to the real-time condition of the user while reducing redundant computation and enhancing the efficiency and responsiveness of the overall information processing system.

The term “user input” refers to information provided by a human user to the system, including at least one of spoken utterances captured as audio signals and code information obtained from an external medium, and used as a trigger for processing by the processor.

The term “voice input” refers to acoustic signals produced by the user's speech, captured by an audio capture device, and processed as an audio signal for subsequent speech recognition and analysis by the processor.

The term “code information” refers to digital data representing an identification code or related data that is stored in or encoded on an external medium, including at least one of an optical code and a wireless tag.

The term “audio signal” refers to a time-varying electrical or digital signal representing sound, including the user's speech, which is suitable for processing by a speech recognition component executed by the processor.

The term “identification code” refers to a data sequence that uniquely or semi-uniquely identifies an object, content item, product, tool, document, or other resource, and that is retrievable from at least one of an optical code and a wireless tag.

The term “optical code” refers to a machine-readable visual pattern, including a one-dimensional or two-dimensional code, which encodes an identification code in a form that can be captured by an image acquisition device and decoded by the processor.

The term “wireless tag” refers to an information storage element that communicates data, including an identification code, via short-range wireless communication, and that can be read by a wireless communication interface of a user device or reader.

The term “information storage device” refers to any hardware, storage medium, or storage system capable of storing digital data, such as product information, document information, or procedure information, and of responding to queries from the processor based on an identification code.

The term “target information” refers to information retrieved by the processor from an information storage device based on an identification code, and representing at least one of product details, document content, schedule information, or operation procedures to be explained to the user.

The term “text data” refers to a sequence of characters or tokens representing linguistic content generated by converting an audio signal into a textual representation or by retrieving or processing stored information.

The term “user attribute” refers to information associated with the user, including at least one of disability type, language preference, age group, skill level, or usage preference, and used by the processor to adjust explanation content.

The term “usage situation” refers to context information indicating circumstances in which the user interacts with the system, including at least one of location type, task type, time context, or device mode, and used by the processor to tailor generated explanations.

The term “prompt sentence” refers to a text string or structured text instruction that specifies to a generative AI model how to process given input data, what type of output to produce, and under what constraints, and that is constructed dynamically by the processor.

The term “generative AI model” refers to a machine-implemented information processing model trained on data to perform generative tasks, including natural language generation, rewriting, summarization, or emotion inference, in response to a prompt sentence and associated input data.

The term “explanation text” refers to text generated by the generative AI model that describes, explains, or summarizes target information or procedures in a form suitable for later transformation into spoken guidance for the user.

The term “emotion analysis prompt sentence” refers to a prompt sentence configured to instruct a generative AI model or an emotion analysis component to infer a user's emotional state from at least one of text data, speech data, or other interaction data.

The term “analysis target information” refers to data used as an input to an emotion analysis process, including at least one of user utterance content, user speech features, facial expressions, or interaction history.

The term “emotion analysis device” refers to any computational component, including a software module or a hardware-implemented unit, that is configured to determine or classify a user's emotional state from analysis target information.

The term “user emotional state” refers to a condition of the user's affect, such as calm, confused, angry, anxious, or happy, inferred by an emotion analysis device or generative AI model, and represented as emotion information used to control subsequent processing.

The term “emotion information” refers to data indicative of the user emotional state, including emotion labels, scores, or probability distributions, used by the processor to adapt text generation and audio output.

The term “adjusted text” refers to explanation text that has been dynamically rewritten or transformed by the generative AI model under control of the processor, such that at least one of linguistic difficulty, amount of information, and number of repetitions is modified in accordance with the user emotional state or other context.

The term “linguistic difficulty” refers to a complexity level of the wording in text, including at least one of vocabulary level, sentence length, syntactic complexity, and conceptual density, which can be increased or reduced by the processor.

The term “amount of information” refers to the quantity or density of content included in explanation text, including the number of concepts, details, or steps, which the processor can expand or compress to suit the user's needs.

The term “number of repetitions” refers to a count or pattern indicating how often key pieces of information or instructions are repeated in explanation text or adjusted text to reinforce understanding.

The term “speech synthesis device” refers to a hardware or software component configured to convert text into audio data representing synthetic speech, under control of the processor.

The term “audio data” refers to digital data representing synthetic speech signals generated by a speech synthesis device, suitable for playback by an audio output device.

The term “audio parameters” refers to control parameters that affect the characteristics of synthesized speech, including at least one of speaking rate, pitch, and prosody, which are set or modified by the processor.

The term “speaking rate” refers to a measure of the speed of speech output, for example in syllables or words per unit time, which can be adjusted dynamically during speech synthesis.

The term “pitch” refers to a perceived fundamental frequency characteristic of the synthesized speech, which can be controlled by the processor to produce higher or lower tones.

The term “prosody” refers to suprasegmental features of speech, including intonation, stress, and rhythm patterns, which can be adjusted to convey different styles or emotional nuances.

The term “visual limitation” refers to a condition in which the user has reduced or no visual capability, requiring that information be conveyed primarily through non-visual modalities such as audio.

The term “cognitive limitation” refers to a condition in which the user has reduced capability to process, remember, or understand complex information or procedures, requiring simplified and structured explanations.

The term “schedule information” refers to data describing temporal arrangements of events, such as meetings, tasks, or appointments, typically contained in electronic documents or records.

The term “work procedure information” refers to data describing steps or instructions for performing tasks, operations, or workflows, including but not limited to procedures for tools, machinery, or business processes.

The term “electronic document data” refers to digital content representing documents, such as text files, markup documents, or database records, obtained or processed by the processor to generate spoken explanations.

The term “summarization prompt sentence” refers to a prompt sentence configured to instruct the generative AI model to generate a condensed representation of electronic document data or other source information.

The term “summarized explanation text” refers to explanation text that provides a condensed, high-level description or outline of more detailed source information, generated in response to a summarization prompt sentence.

The term “inquiry voice” refers to voice input containing at least one user question or request for information regarding an event, a tool, or a procedure.

The term “event that is likely to be forgotten” refers to a situation, rule, or piece of knowledge that users with cognitive limitations frequently fail to recall, such as infrequent tasks or rare exceptions.

The term “equipment that is infrequently used” refers to a device, tool, or machine that the user operates only occasionally, and for which operation procedures are not regularly recalled.

The term “operation procedure information” refers to data describing stepwise instructions or rules for operating equipment, performing tasks, or using tools in a correct and safe manner.

The term “procedure explanation prompt sentence” refers to a prompt sentence configured to instruct the generative AI model to generate stepwise, short-sentence explanations of operation procedures.

The term “stepwise short-sentence procedure explanation text” refers to explanation text in which an operation procedure is divided into discrete steps, each expressed in a concise sentence suitable for audio guidance.

The term “division of text” refers to the operation of splitting explanation text into smaller units, such as sentences or step segments, to improve clarity and pacing for the user.

The term “repetition of text” refers to the operation of reiterating selected parts of explanation text or adjusted text to reinforce important information or instructions.

The term “simplification of expression” refers to transforming text so that complex words, structures, or concepts are replaced with more basic, easier-to-understand language.

The term “audio information” refers to information presented in auditory form to the user, including synthesized speech generated from adjusted text or other textual content.

The term “history data” refers to stored records linking explanation text, prompt sentences, user emotional states, and optionally other interaction metadata, which are maintained by the server for reuse.

The term “reuse in subsequent processing” refers to the operation of employing history data, including stored prompts, explanation text, and emotional states, to influence later generation of explanation text, emotion estimation, or audio output adjustment in subsequent user interactions.

In one embodiment, a server, a terminal, and a network configure a system that assists users having visual or cognitive limitations by generating and adapting spoken guidance using a generative AI model controlled by prompt sentences. The server comprises at least one processor, at least one memory, a network interface, and access to at least one information storage device. The terminal comprises a processor, a memory, an audio capture device such as a microphone, an audio output device such as a speaker or headphones, and at least one input device such as a camera, a code reader, or a wireless tag reader.

The server stores in the memory executable instructions that, when executed by the processor, realize a plurality of functional units, including a speech recognition unit, an information retrieval unit, a prompt construction unit, a generative AI inference unit, an emotion analysis unit, a text adjustment unit, a speech synthesis control unit, and a history management unit.

The server also maintains data structures such as user profiles, interaction logs, and model configuration parameters in the information storage device.

The terminal acquires user input via hardware interfaces. The terminal uses the microphone to convert acoustic pressure waves of the user's speech into digital audio signals via an analog-to-digital converter. The terminal uses the camera to capture images of optical codes, such as one-dimensional barcodes or two-dimensional codes, and uses a wireless communication module, such as a near field communication module, to acquire data from wireless tags. The terminal executes code that decodes optical codes and wireless tags into identification codes, which the terminal encapsulates together with metadata, such as timestamps and user identifiers, and transmits to the server via the network interface.

The server receives user voice input and code information as network messages and stores them temporarily in memory as structured data records. The server uses a speech recognition unit implemented by an automatic speech recognition engine to convert the audio signal into text data. In one embodiment, the server uses a sequence-to-sequence neural network comprising an acoustic encoder and a linguistic decoder. The server processes acoustic features such as mel-frequency cepstral coefficients or log-mel spectrograms as input to a recurrent or transformer-based acoustic model and applies a decoding algorithm, such as beam search with a language model, to output a sequence of text tokens representing the user's utterance.

The server uses the information retrieval unit to query the information storage device based on identification codes received from the terminal. The information storage device stores structured items such as product records, document records, schedule entries, and operation procedures in a relational schema or document schema. The server forms database queries that use the identification code as a key and retrieves target information that includes fields such as title, description, usage instructions, ingredients, steps, or timestamps. The server normalizes the retrieved fields by stripping markup, unifying units, and converting numerical values, such as prices or times, into language-oriented formats.

The server uses a prompt construction unit to generate a prompt sentence for a generative AI model. The server reads the user attribute and usage situation from stored user profile records and interaction context. The user attribute may include one or more flags indicating visual limitation, cognitive limitation, preferred language, or proficiency level. The usage situation may indicate environment type, such as retail store, factory, home, or office, as well as task category, such as product explanation, tool instruction, or meeting agenda explanation. The server combines this context with the text data and target information to construct a prompt sentence.

The server performs prompt construction using a rule-based template engine that specifies non-conventional combinations of fields and constraints. In one example, the server constructs a prompt sentence for a visually impaired user about a product as follows:
“The user is visually impaired.
Create a spoken explanation of the following product in simple language.
Product name: Organic Tomato
Price: 300 yen
Usage: For salads and cooking
Allergens: None
Constraints:
1. Use short, clear sentences.
2. Start with the product name and price.
3. Then describe how to use it and mention allergens.
Output only the text that should be read aloud.”
In another example, the server constructs a prompt sentence for a user having a cognitive limitation who requests tool usage guidance:
“Explain how to use scissors in very simple language for a user with a cognitive limitation.
Use very short steps.
Mention safety rules.
Output only the explanation text for spoken use.”

The server uses a generative AI inference unit to execute a generative AI model that receives the prompt sentence and the associated text data or target information as input. In one embodiment, the generative AI model is implemented as a transformer-based neural network with multiple encoder-decoder layers, attention mechanisms, and feed-forward sublayers. The server stores in the memory model parameters such as layer widths, number of attention heads, positional encoding schemes, and vocabulary definitions. The server loads learned weight matrices, bias vectors, and normalization parameters from a model storage.

The server causes the generative AI model to perform inference by passing tokenized prompt sentences and input sequences into the model and computing hidden representations layer by layer. The model generates output tokens representing explanation text using a decoding algorithm such as greedy decoding or top-k sampling with temperature control. The server reconstructs the explanation text string from the output tokens. The explanation text may describe the product, summarize a document, or provide stepwise instructions, depending on the prompt sentence.

The server processes emotion information using an emotion analysis unit. The terminal supplies either raw audio of the user's utterance, derived acoustic features, facial image data, or transcribed text to the server. The server extracts features such as pitch contour, energy envelope, speaking rate, pause distribution, facial action units, or lexical markers. The server inputs these features to an emotion classification model implemented as a neural network, such as a convolutional network for images, a recurrent network for acoustic sequences, or a transformer for textual sequences.

In one embodiment, the server also uses a generative AI model to interpret text associated with the user's utterance. The server constructs an emotion analysis prompt sentence such as:
“From the following user speech transcript, output only one label that best describes the emotion: calm, confused, angry, anxious, or happy.
Transcript: ‘I don't understand this product. Can you explain again more slowly?’”

The server transmits the emotion analysis prompt sentence and the transcript to the generative AI model and receives an emotion label. The server combines this label with the output of the dedicated emotion classification model to increase robustness. The server maintains a probabilistic representation of emotional state in the memory and updates this representation over time using, for example, an exponential moving average or a Bayesian updating rule. By fusing multiple emotion indicators, the server reduces misclassification errors and increases stability of emotion estimation.

The server uses the text adjustment unit to transform explanation text into adjusted text that satisfies constraints determined by the user attribute, the usage situation, and the current emotional state. The server constructs a second prompt sentence that explicitly instructs the generative AI model to rewrite text. For example, when the user is confused, the server constructs a rewrite prompt such as:
“The user is confused and may have a cognitive limitation.
Rewrite the following explanation in even simpler language.
Use very short sentences, slow pacing, and repeat key points.
Text: ‘This product is an organic tomato. The price is 300 yen. You can eat it raw in salads or cook it in pasta and soups. It does not contain any known allergens.’”

The server submits this rewrite prompt and the original explanation text to the generative AI model and receives adjusted text. The adjusted text exhibits systematically reduced linguistic difficulty, lower information density, and higher repetition. The server additionally applies rule-based post-processing, such as splitting long sentences at conjunctions, inserting pauses markers, and reordering clauses so that safety warnings and key instructions appear early and at the end.

The server uses a speech synthesis control unit to convert adjusted text into audio data. The server accesses a speech synthesis device implemented by a text-to-speech engine. The server configures the speech synthesis parameters based on the emotional state and the user attribute.

For instance, the server sets a lower speaking rate and narrower pitch range for anxious or confused users and a standard rate for calm users. The server encodes these parameters as input to the speech synthesis engine, which uses a parametric synthesis or neural vocoder architecture to generate time-domain waveforms. The server obtains audio data in a digital format such as pulse code modulation or compressed bitstream.

The terminal receives the audio data via the network interface and uses the audio output device to render the audio to the user. The terminal writes the digital audio stream into an audio buffer and uses a digital-to-analog converter and an amplifier to drive the speaker. As a result, the user hears spoken guidance that is not only semantically adapted to the user's needs but also acoustically optimized to the user's emotional condition.

The server uses the history management unit to persist information about each interaction.

The server stores, in the information storage device, records that link each prompt sentence, explanation text, adjusted text, emotion information, and metadata such as timestamps, device identifiers, and task types. The server indexes these records by user identifier and by canonicalized query content. When the server receives a new query similar to a previous one, the server searches the history and may reuse or partially reuse an earlier explanation text or adjusted text. The server then updates only the parts that depend on changed context, such as current prices or updated procedures. Because the server avoids recomputing explanations from scratch in such cases, the system reduces inference time and network traffic to the generative AI model, improving processing speed and communication efficiency.

In one concrete example, the user stands in front of a supermarket shelf, points the terminal camera at a code associated with a product, and requests information by saying “Please tell me about this product.” The terminal decodes the code into an identification code and transmits the code and the audio to the server. The server converts the audio into text, queries the product record, constructs a prompt sentence instructing the generative AI model to describe the product for a visually impaired user, generates explanation text, analyzes the user's emotional state, rewrites the explanation text if confusion is detected, and synthesizes audio with adjusted speaking rate and prosody. The terminal plays the audio: “This is an organic tomato. The price is 300 yen. You can eat it raw in salads, or cook it in pasta or soup. It has no common allergens.”

In another example, the user at home asks the terminal “Please tell me how to use the microwave.” The terminal records the speech and sends the audio to the server. The server recognizes the text, looks up an operation procedure, and constructs a procedure explanation prompt sentence such as:
“Explain how to use a microwave oven in very simple language for a user with a cognitive limitation.
Use short, numbered steps.
Mention safety rules, such as avoiding metal objects and covering food.
Output only the instructions.”

The server generates stepwise short-sentence procedure explanation text, such as “Step 1: Plug in the microwave. Step 2: Put the food in a microwave-safe container. Step 3: Do not use metal. Step 4: Close the door. Step 5: Set the time. Step 6: Press start.” The server then, using emotion information, may further divide or repeat steps if confusion is detected and synthesize audio in a calm tone. The terminal outputs the spoken instructions, allowing the user to operate the device safely without reading a manual.

The server, by tightly integrating generative AI inference, emotion classification, history management, and parameterized speech synthesis, improves the operation of the computer system itself. The server uses specialized data structures and models rather than merely automating a human mental process. The server's use of prompt sentences in combination with generative AI models and emotion-dependent rewriting enables dynamic restructuring of text that would not be feasible with static templates or simple rule sets. The server uses non-conventional control flows, where emotion feedback and prior history influence subsequent prompts, thereby forming a closed-loop adaptation mechanism at the system level.

The server implements training or fine-tuning of the generative AI model and the emotion model prior to deployment. The server collects training data consisting of pairs of input prompts and desired outputs, including simplified explanations for different user attributes and emotional states. The server defines loss functions such as cross-entropy over output tokens for text generation and categorical cross-entropy for emotion classification. The server updates model weights by stochastic gradient descent or related optimization algorithms, such as adaptive moment estimation. The server may apply data augmentation techniques, such as synonym replacement, sentence shuffling within constraints, and noise injection into acoustic features, to improve robustness and generalization. Through this training procedure, the models learn patterns of simplification and emotional adaptation that are specifically tuned to the system's interaction tasks and constraints.

The server benefits from technical effects including reduced latency, improved personalization accuracy, lower misinterpretation rates, and reduced cognitive load for users.

Because the server uses the history management unit to reuse prior prompts and explanations, the server reduces calls to the generative AI model for repeated or similar queries, thus lowering computational cost and network usage. Because the server uses emotion-aware rewriting controlled by explicit prompt sentences and model parameters, the server reduces the probability that the user will require multiple clarifications, thereby shortening average interaction duration and decreasing total processing effort across many sessions.

In variant embodiments, the server may host the generative AI model locally on specialized hardware, such as a graphics processing unit or an application-specific accelerator, or may access the model via a remote inference service. The server may vary the architecture of the generative AI model, such as by changing the number of layers, attention heads, or embedding dimensions, depending on deployment constraints. The server may employ different speech recognition, speech synthesis, and emotion classification engines, provided that the functional relationships among prompt construction, text generation, emotion analysis, text adjustment, and audio output control are maintained.

The terminal may take different forms, such as a handheld device, a wearable device, or a fixed kiosk, provided that the terminal can capture user input and output audio under control of the server. The server may process additional sensor data, such as motion sensors or environmental noise levels, to refine the usage situation and further adjust prompts and speech parameters. These variations preserve the core concept that the server uses generative AI models under explicit prompt control, combined with emotion-aware adjustment and history-based optimization, to improve the technical performance and adaptability of a computer-implemented audio guidance system.

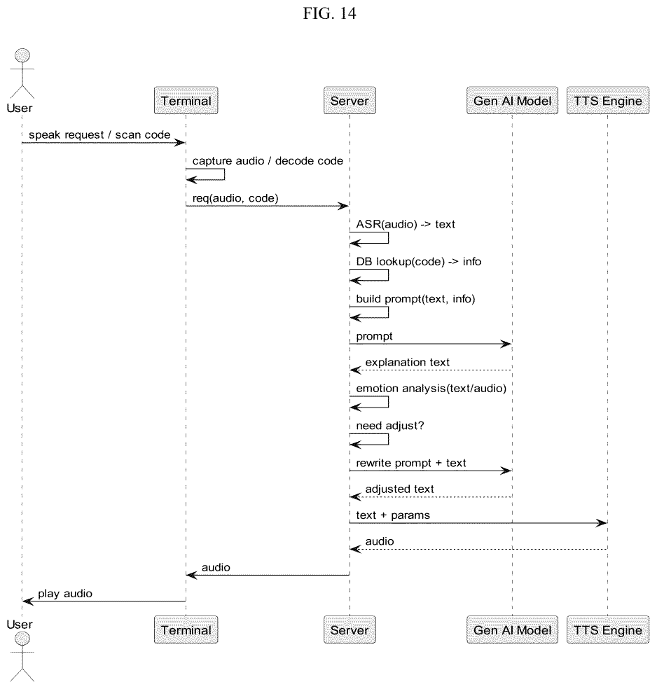

The following describes the processing flow using FIG. 14.

Step 1:
The user provides an initial request.
The user speaks a request such as “Please tell me about this product” or “Please tell me how to use the microwave,” and optionally points the terminal camera at an optical code or brings the terminal close to a wireless tag.
Input: Human speech and, optionally, an optical code image or wireless tag signal.
Output: Acoustic pressure waves at the microphone, image frames at the camera, and wireless signals at the wireless interface.

Step 2:
The terminal acquires raw sensor data.
The terminal uses an analog-to-digital converter to sample the microphone signal and stores the sampled waveform as digital audio data in a buffer. The terminal activates the camera to capture image frames containing the optical code and runs a code-decoding library to crop and preprocess the region of interest. The terminal activates a wireless tag interface to read the payload from a wireless tag and stores the payload as a byte array.
Input: Acoustic pressure waves, optical image, wireless tag RF signal.
Output: Digital audio data, digital image data, and wireless tag payload data.

Step 3:
The terminal decodes identification codes and creates a request payload.
The terminal executes an optical code decoding algorithm, which converts the captured image into grayscale, detects finder patterns, samples the code grid, and decodes the encoded bits to obtain an identification code string. The terminal parses the wireless tag payload to extract a corresponding identification code. The terminal packages the identification code, device identifier, timestamp, and optional preliminary user context into a structured message. The terminal attaches the audio data or a link to the stored audio buffer.
Input: Digital image data, wireless tag payload data, digital audio data.
Output: A network request payload containing an identification code, audio data, and metadata.

Step 4:
The terminal transmits the request to the server.
The terminal opens a secure network connection using a communication protocol and sends the structured payload to a predetermined server endpoint. The terminal handles segmentation and reassembly of packets and ensures that the entire payload is delivered with integrity.
Input: Request payload generated in Step 3.
Output: Serialized network packets transmitted to the server.

Step 5:
The server receives and parses the request.
The server accepts the network packets at a network interface and reconstructs the original request payload. The server verifies authentication tokens and checks required fields. The server parses the payload into internal data structures, separating the audio data, identification code, user identifier, and other metadata.
Input: Serialized network packets containing the request payload.
Output: In-memory objects representing audio data, identification code, user identifier, and context.

Step 6:
The server performs speech recognition on the audio data.
The server passes the audio data to a speech recognition engine. The server computes acoustic features such as log-mel spectrograms by applying windowing and Fourier transforms to the waveform. The server inputs the features to an acoustic model, which may be a neural network, and obtains posterior probabilities over phonetic or subword units. The server applies a decoding algorithm with a language model to derive the most probable token sequence. The server concatenates tokens to create text data representing the user utterance.
Input: Digital audio data from Step 5.
Output: Text data representing the transcribed user utterance.

Step 7:
The server retrieves target information from the information storage device.
The server uses the identification code to construct a query to a data store. The server sends the query to the information storage device, which returns matching records such as product information, document content, schedule entries, or operation procedures. The server extracts relevant fields from the records and normalizes them by removing markup, converting units, and formatting numbers.
Input: Identification code from Step 5.
Output: Target information object containing normalized product data, document data, or procedure data.

Step 8:
The server determines user attributes and usage situation.
The server looks up the user identifier in a user profile store to obtain attributes such as visual limitation, cognitive limitation, language preference, and skill level. The server evaluates the current context, including location or task type, to classify the usage situation as retail product explanation, tool usage guidance, meeting agenda explanation, or similar categories.
Input: User identifier and context metadata from Step 5.
Output: User attribute data and usage situation classification.

Step 9:
The server constructs a primary prompt sentence for the generative AI model.
The server uses a template engine to assemble a prompt sentence that instructs the generative AI model how to generate explanation text. The server selects a template based on the usage situation and user attributes. The server inserts dynamic fields from the target information and constraints appropriate for the user. For example, the server may create a prompt sentence:
“The user is visually impaired.
Create a spoken explanation of the following product in simple language.
Product name: Organic Tomato
Price: 300 yen
Usage: For salads and cooking
Allergens: None
Constraints:
1. Use short, clear sentences.
2. Start with the product name and price.
3. Then describe how to use it and mention allergens.
Output only the text that should be read aloud.”
Input: User attribute data, usage situation classification, and target information.
Output: A primary prompt sentence string and associated parameter set.

Step 10:
The server executes the generative AI model to generate explanation text.
The server tokenizes the prompt sentence and any supplemental text and feeds the tokens into the generative AI model as input. The server runs a forward pass through the model, layer by layer, applying linear transformations, attention operations, and non-linear activations to compute output token probabilities. The server then uses a decoding strategy to select an output sequence. The server converts the output token sequence back into a human-readable string as explanation text.
Input: Primary prompt sentence and associated input text.
Output: Explanation text describing the target information.

Step 11:
The server collects data for emotion analysis.
The server uses the recognized text, audio features, and any additional user behavior data received from the terminal to prepare analysis target information. The server extracts features such as pitch contour and speaking rate from the audio and may annotate the text with markers indicating hesitations or repeated phrases. The server organizes these elements into a feature vector or structured object for emotion analysis.
Input: Audio data from Step 5, text data from Step 6, and optional behavior metadata.
Output: Analysis target information structured for emotion analysis.

Step 12:
The server determines the user emotional state.
The server inputs the analysis target information into an emotion classification component.
The server may also construct an emotion analysis prompt sentence, such as:
“From the following user speech transcript, output only one label that best describes the emotion: calm, confused, angry, anxious, or happy.
Transcript: ‘I don't understand this product. Can you explain again more slowly?’”
The server feeds this prompt and transcript into the generative AI model or a dedicated emotion model. The server obtains an emotion label or a probability distribution over emotion categories and selects the most probable emotional state. The server updates an internal record of the current emotional state for the user.
Input: Analysis target information and, optionally, an emotion analysis prompt sentence.
Output: User emotional state label and associated confidence values.

Step 13:
The server decides whether explanation text adjustment is required.
The server compares the emotional state against predefined rules. If the state is calm, the server may skip rewriting. If the state is confused, anxious, or angry, the server sets an adjustment flag and determines adjustment parameters such as target linguistic difficulty, target information density, and desired repetition level.
Input: Emotional state label from Step 12.
Output: Adjustment decision flag and adjustment parameter values.

Step 14:
The server constructs a rewrite prompt sentence for adjusted text.
If adjustment is required, the server creates a rewrite prompt sentence instructing the generative AI model to transform the explanation text according to the adjustment parameters.
For example, the server may construct:
“The user is confused and may have a cognitive limitation.
Rewrite the following explanation in even simpler language.
Use very short sentences, slow pacing, and repeat key points.
Text: ‘This product is an organic tomato. The price is 300 yen. You can eat it raw in salads or cook it in pasta and soups. It does not contain any known allergens.’”
Input: Explanation text from Step 10 and adjustment parameter values from Step 13.
Output: Rewrite prompt sentence string.

Step 15:
The server generates adjusted text using the generative AI model.
The server tokenizes the rewrite prompt sentence and the original explanation text and feeds them into the generative AI model. The server runs inference and obtains a new output token sequence representing adjusted text. The server converts the tokens to a text string. The server may apply post-processing, such as further sentence splitting or insertion of markers for pauses.
Input: Rewrite prompt sentence and original explanation text.
Output: Adjusted text with modified linguistic difficulty, information amount, and repetition.

Step 16:
The server selects the text for speech synthesis.
The server chooses either the original explanation text or the adjusted text based on the adjustment decision. The server also determines speech parameters such as speaking rate, pitch, and prosody pattern in accordance with the emotional state and user attributes.

Input: Explanation text from Step 10, adjusted text from Step 15, emotional state from Step 12, and user attributes from Step 8.
Output: Selected text for speech synthesis and associated speech parameter set.

Step 17:
The server performs speech synthesis to generate audio data.
The server passes the selected text and the speech parameters to a speech synthesis engine.
The engine converts text into phonetic or linguistic units, predicts acoustic features, and generates a waveform using a synthesis model or vocoder. The server receives the resulting audio data and encapsulates it in a format suitable for streaming or download.
Input: Selected text and speech parameter set from Step 16.
Output: Audio data representing synthetic speech.

Step 18:
The server sends the audio data and logs the interaction history.
The server transmits the audio data to the terminal via the network interface. The server creates a history record linking the primary prompt sentence, any rewrite prompt sentence, the explanation text, the adjusted text, the emotional state, and identifiers for the user and task.
The server stores this history record in the information storage device and indexes it for future retrieval.
Input: Audio data from Step 17, prompt sentences, explanation text, adjusted text, emotional state, and metadata.
Output: Network packets carrying audio data to the terminal and stored history records.

Step 19:
The terminal plays back the audio to the user.
The terminal receives the audio data and writes it into a playback buffer. The terminal configures the audio output device according to default or user-specific volume settings. The terminal streams the audio samples through a digital-to-analog converter and drives the speaker so that the user hears the spoken explanation or instructions.
Input: Audio data from Step 18.
Output: Audible sound conveying explanation or instructions to the user.

Step 20:
The user optionally issues follow-up questions.
The user listens to the spoken output and, if further clarification is needed, asks an additional question such as “Please explain that again more slowly” or “Can I use this in the microwave?” The terminal and server repeat Steps 2 through 19, using updated context and history records, so that the new interaction benefits from previous prompts, explanations, emotional state tracking, and adjustments.
Input: New human speech and existing interaction history.
Output: New digital audio input and updated guidance based on accumulated history and context.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

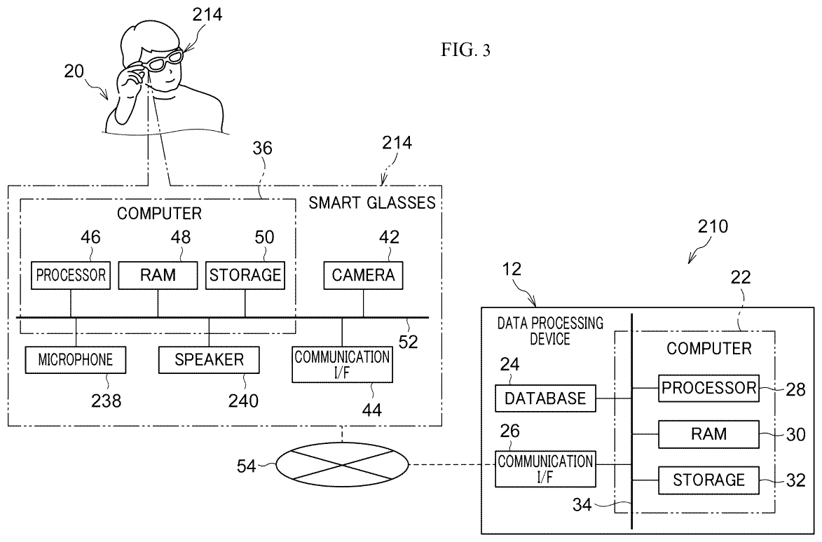

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

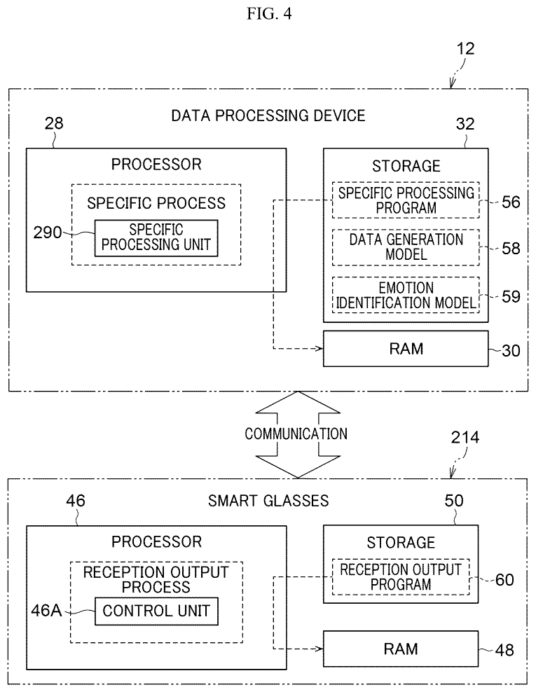

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

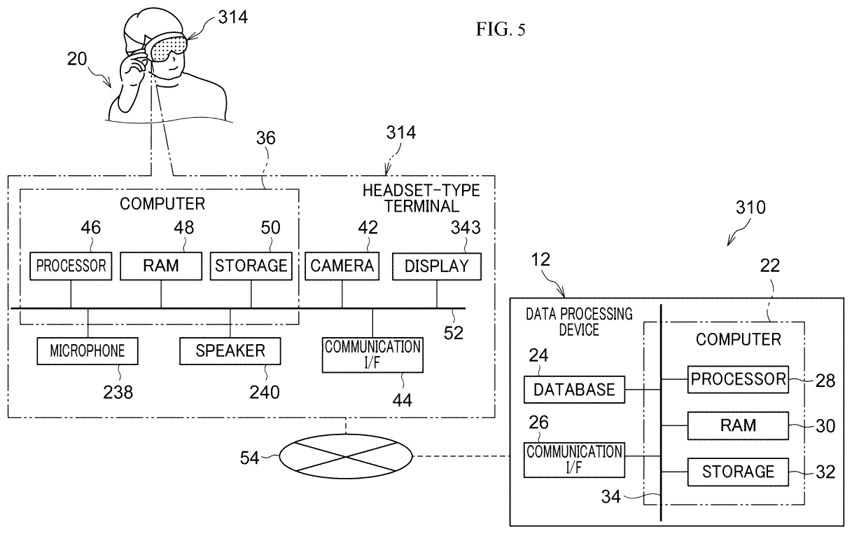

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

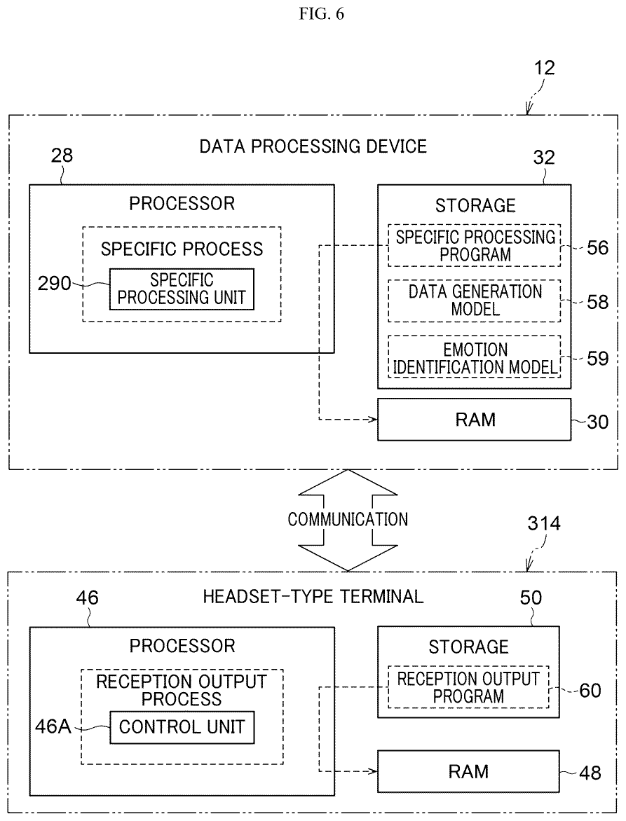

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

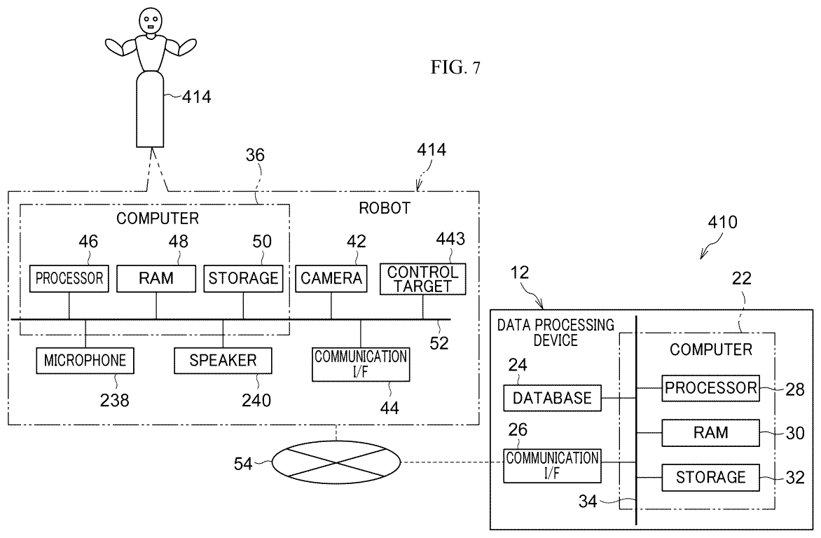

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

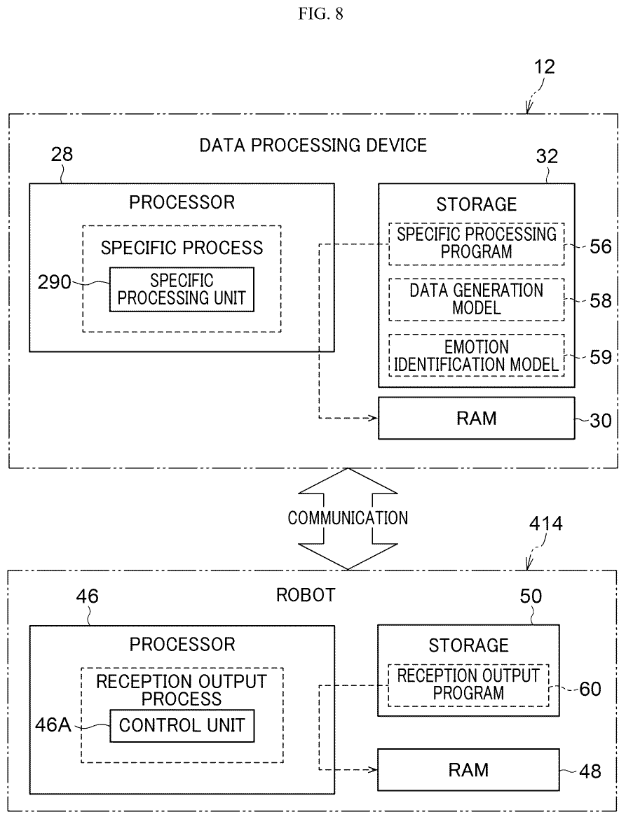

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

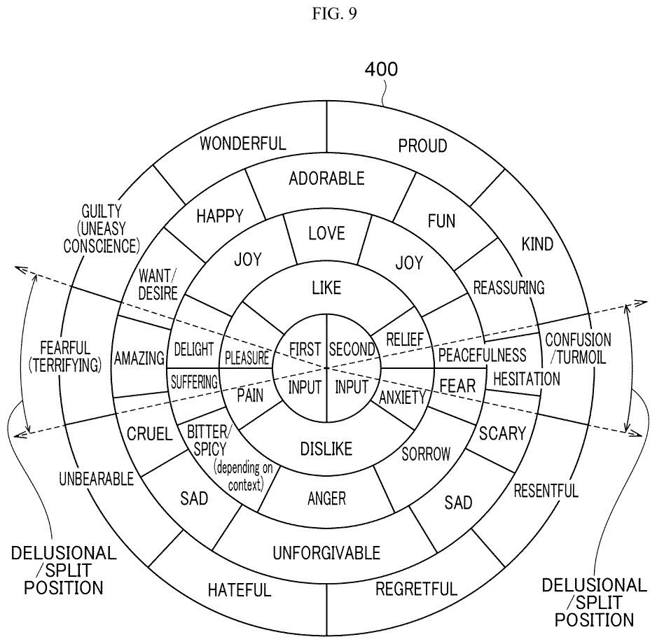

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

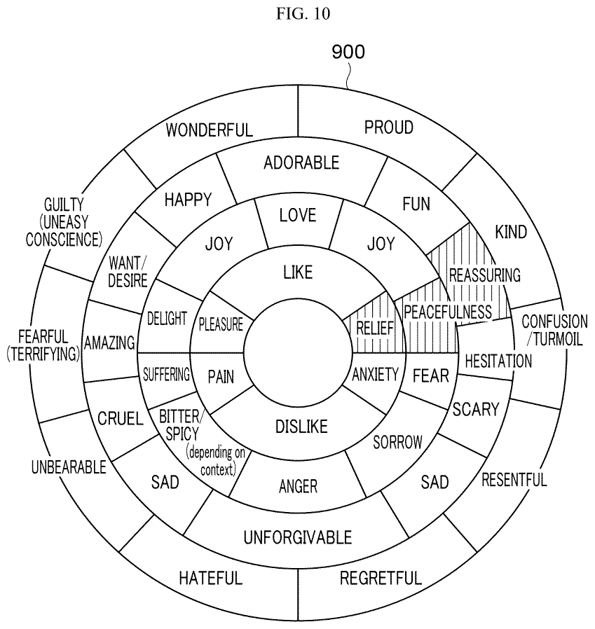

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

(supplementary 1)

A system comprising a processor,
wherein the processor is configured to
acquire input information including character information or audio information from a user,
and receive a processing request type together with the input information,
convert the audio information into character information by audio analysis processing, or
convert the character information into standardized character information by format
conversion processing,
generate a prompt sentence that designates at least one of summarization processing and
simplification processing based on the processing request type and the input information, and
generate generation input data including the prompt sentence and the input information, input the generation input data to a generative information processing model and generate summary character information or easy-to-understand character information from long character information,
convert the summary character information or the easy-to-understand character information into audio information by speech synthesis processing, and generate audio data corresponding to an output medium,
dynamically change the prompt sentence for the generative information processing model or an audio output condition of the speech synthesis processing based on user attribute information or usage situation information, and determine an information output mode adapted to at least one of a visually impaired user and an intellectually disabled user, and
transmit at least one of the audio data and the summary character information or the easy-to-understand character information to a terminal via a communication path so that the terminal reproduces or displays the transmitted data.

(Supplementary 2)

The system according to supplementary 1,
wherein the processor is configured to, when the processing request type relates to meeting information or work procedure information, use the generative information processing model to generate the summary character information from the meeting information or the work procedure information, convert the summary character information into the audio information, and provide the audio information as work-related information to be checked in advance by the visually impaired user.

(Supplementary 3)

The system according to supplementary 1,
wherein the processor is configured to, when the processing request type relates to a low-frequency-use work instrument or a work procedure, use the generative information processing model to simplify explanation information relating to the work instrument or the work procedure, and output the simplified explanation information as the audio information so that the intellectually disabled user can repeatedly receive information relating to matters that are easily forgotten or to usage methods.

### Application Example 1

(Supplementary 1)

A system comprising a processor,
wherein the processor is configured to
receive audio input from a user and acquire acoustic data,
convert the acoustic data into character string data by performing speech recognition processing,
analyze the character string data to identify a request content of the user and a target item, and
acquire a section position corresponding to the target item,
calculate a route within a facility on the basis of the section position and a user position, and
generate route information relating to the route within the facility,
acquire attribute information relating to the target item from an information storage unit,
generate a prompt sentence including explanation information comprising the route information and the attribute information, and including constraint conditions regarding a speech style and a difficulty level,
input the prompt sentence to a generative information processing model and cause the generative information processing model to generate a summarized text for a visually impaired person or an intellectually disabled person on the basis of the explanation information,
convert the summarized text into acoustic data by performing speech synthesis processing, and
output the acoustic data as guidance speech via an output device to support movement of the user and understanding of the target item.

(Supplementary 2)

The system according to supplementary 1,
wherein the processor is configured to
generate the prompt sentence so as to include a description that instructs the generative information processing model to convert long text relating to meeting information, work procedure information, or merchandise information into short and simple expressions, and to cause the summarized text to be generated as a voice guidance text for the visually impaired person or the intellectually disabled person.

(Supplementary 3)

The system according to supplementary 1,
wherein the processor is configured to
generate the route information as sequential movement instruction text on the basis of position data representing a sectional structure of a store, a business site, or a public facility, and to generate the summarized text as a voice guidance text obtained by integrating the movement instruction text and the attribute information of the target item.

### Example 2

(Supplementary 1)

A system comprising a processor,
wherein the processor is configured to obtain electronic information from a user, and
analyze the electronic information to extract character information and convert the character information into structured information, and
generate an instruction sentence to be input to a generative information processing model on the basis of the structured information and instruction information given by the user, and
input the instruction sentence and the structured information into the generative information processing model to cause the generative information processing model to generate explanation information, and
convert the explanation information into audio information, and
transmit the audio information to an output apparatus and cause the output apparatus to output the audio information, and
adjust a content of the explanation information or an output condition of the audio information on the basis of attribute information and state information of a user having an impairment in visual function or a user having an impairment in cognitive function.

(Supplementary 2)

The system according to supplementary 1,
wherein the processor is configured to
treat the electronic information as document information including progress schedule information of a meeting or work procedure information, extract time information and item information from the document information to generate the structured information, use the generative information processing model to generate explanation information in a colloquial form suitable for audio presentation, and enable a user having an impairment in visual function to grasp in advance the progress schedule information of the meeting or the work procedure information.

(Supplementary 3)

The system according to supplementary 1,
wherein the processor is configured to
treat the electronic information as use procedure information of a low-frequency-use tool or explanation information regarding matters that are difficult to memorize, generate, as the instruction sentence for the generative information processing model, an instruction sentence including an instruction to explain in short sentences and stepwise for a user having an impairment in cognitive function, cause the generative information processing model to generate the explanation information including simplified procedure information, and provide the explanation information as the audio information.

### Application Example 2

(Supplementary 1)

A system comprising a processor,
wherein the processor is configured to
receive user input including at least one of voice input and code information, the processor being configured to acquire the voice input as an audio signal and to acquire the code information as an identification code from at least one of an optical code and a wireless tag,
analyze the audio signal and convert the audio signal into text data, and acquire target information from an information storage device on the basis of the identification code,
construct a prompt sentence for a generative AI model on the basis of at least one of the text data and the target information in accordance with a user attribute and a usage situation, and input the prompt sentence and at least one of the text data and the target information into the generative AI model so as to cause the generative AI model to generate explanation text,
input at least one of an emotion analysis prompt sentence relating to the explanation text and analysis target information relating to at least one of user utterance and user expression into at least one of the generative AI model and an emotion analysis device, and identify a user emotional state as emotion information,
dynamically rewrite the explanation text by using the generative AI model, on the basis of the explanation text and the emotional state, so as to convert the explanation text into adjusted text by changing at least one of linguistic difficulty, amount of information, and number of repetitions included in the text,
input the adjusted text into a speech synthesis device to generate audio data, and control audio parameters including at least one of speaking rate, pitch, and prosody in accordance with the emotional state, and output the audio data to the user, and
store the explanation text, the prompt sentence, and the emotional state in association with one another, and reuse the stored data for at least one of subsequent generation of explanation text and subsequent adjustment of audio output.

(Supplementary 2)

The system according to supplementary 1,
wherein the processor is configured to
acquire, as electronic document data, schedule information or work procedure information which is to be confirmed in advance by a user having a visual limitation, input the electronic document data together with a summarization prompt sentence into the generative AI model so as to generate summarized explanation text, reconstruct the summarized explanation text by using the adjusted text processing in accordance with the emotional state, and provide the reconstructed summarized explanation text as audio information.

(Supplementary 3)

The system according to supplementary 1,
wherein the processor is configured to
use, as input, at least one of inquiry voice and identification code relating to at least one of an event that is likely to be forgotten and an operating procedure of equipment that is infrequently used by a user having a cognitive limitation, acquire operation procedure information on the basis of at least one of the inquiry voice and the identification code, input the operation procedure information together with a procedure explanation prompt sentence into the generative AI model so as to generate stepwise short-sentence procedure explanation text, and, in accordance with the emotional state, perform at least one of division, repetition, and simplification of expression of the procedure explanation text and then provide the resulting text as audio information.

What is claimed is:

1. A system comprising:
circuitry configured to:
receive, via a communication interface coupled to a packet-switched network, input data including at least one of character data and signal data from a terminal device;
convert the signal data into character data by applying a neural network model that maps an acoustic feature sequence to a token sequence;
generate a prompt data structure designating at least one of a compression operation and a transformation operation on the character data, and construct generation input data including the prompt data structure and the character data;
input the generation input data to a generative neural network model to generate output character data representing a condensed or restructured form of the character data;
convert the output character data into output signal data by applying a synthesis model that generates a waveform representation; and
transmit the output signal data to the terminal device via the packet-switched network.

2. The system according to claim 1, wherein the neural network model comprises a sequence-to-sequence architecture including an acoustic encoder that receives the acoustic feature sequence and a linguistic decoder that generates the token sequence, and the circuitry applies a decoding algorithm to select the token sequence from a plurality of candidate token sequences.

3. The system according to claim 2, wherein the acoustic feature sequence comprises at least one of mel-frequency cepstral coefficient vectors and log-mel spectrogram frames computed from the signal data, and the decoding algorithm comprises beam search constrained by a language model.

4. The system according to claim 3, wherein the circuitry normalizes user attribute data associated with the terminal device, the user attribute data indicating at least one of a perceptual characteristic, a cognitive characteristic, a language preference, and a proficiency level, and maps the user attribute data to a set of processing parameters that control at least one of a target compression ratio and a target linguistic complexity level for the prompt data structure.

5. The system according to claim 4, wherein the perceptual characteristic indicates a visual impairment and the cognitive characteristic indicates an intellectual disability, and the circuitry selects a prompt template from a plurality of stored prompt templates on the basis of the user attribute data and a processing request type received together with the input data.

6. The system according to claim 1, wherein the generative neural network model comprises a transformer architecture including a token embedding layer, a positional encoding mechanism, a plurality of self-attention layers, and feedforward sublayers, and the circuitry controls at least one of a temperature parameter, a maximum output length, and a sampling threshold during generation of the output character data.

7. The system according to claim 6, wherein the circuitry, when a token length of the character data exceeds a predetermined threshold, segments the character data at boundary positions into a plurality of segments, generates intermediate output character data for each segment by inputting each segment with a corresponding prompt data structure to the generative neural network model, and generates consolidated output character data by inputting the intermediate output character data with a consolidation prompt data structure to the generative neural network model.

8. The system according to claim 7, wherein the circuitry caches the output character data in association with a hash value computed from the character data and the prompt data structure, and, upon receiving subsequent input data matching the hash value, retrieves the cached output character data without re-executing the generative neural network model.

9. The system according to claim 1, wherein the circuitry further estimates an emotional state of a user associated with the terminal device by applying an emotion classification model to analysis target data derived from at least one of the signal data and the character data, and adjusts at least one of the prompt data structure and an output parameter of the synthesis model on the basis of the estimated emotional state.

10. The system according to claim 9, wherein the analysis target data comprises at least two of a pitch contour, an energy envelope, a speaking rate, facial action unit values extracted from image data received from the terminal device via the packet-switched network, and lexical markers extracted from the character data, and the emotion classification model fuses the at least two to generate a probabilistic representation of the emotional state.

11. The system according to claim 10, wherein the circuitry updates the probabilistic representation over successive interactions by applying at least one of an exponential moving average and a Bayesian updating rule, and, when the emotional state indicates at least one of confusion and anxiety, constructs a rewrite prompt data structure that instructs the generative neural network model to reduce a linguistic difficulty, lower an information density, and increase a repetition count of the output character data.

12. The system according to claim 1, wherein the synthesis model comprises a neural text-to-speech architecture including an encoder-decoder with an attention mechanism that generates a spectrogram representation from the output character data, and a vocoder that converts the spectrogram representation into the waveform representation.

13. The system according to claim 12, wherein the circuitry inserts prosody control markers into the output character data prior to input to the synthesis model, the prosody control markers specifying at least one of a speech rate, a pitch value, a volume level, a pause duration, and an emphasis indicator, and determines values for the prosody control markers on the basis of at least one of user attribute data associated with the terminal device and a complexity score computed from the output character data.

14. The system according to claim 1, wherein the input data comprises electronic document data, and the circuitry extracts the character data from the electronic document data by applying at least one of a document parsing operation and an optical character recognition operation, and converts the extracted character data into a structured data representation including time information fields and item information fields.

15. The system according to claim 14, wherein the electronic document data represents at least one of progress schedule information of a meeting and work procedure information, and the circuitry generates the prompt data structure to instruct the generative neural network model to convert the structured data representation into a colloquial form suitable for audio presentation, segmented by the time information fields.

16. The system according to claim 1, wherein the circuitry receives, from the terminal device via the packet-switched network, an identification code obtained from at least one of an optical code and a wireless tag, retrieves target information from a storage device on the basis of the identification code, and incorporates the target information into the generation input data together with the prompt data structure.

17. The system according to claim 16, wherein the circuitry further receives position data from the terminal device, computes a route within a facility on the basis of the position data and a section position associated with the identification code by applying a graph-based shortest path algorithm to facility layout data stored in the storage device, and generates the prompt data structure to include route information and attribute information of a target item corresponding to the identification code.

18. A system comprising:
circuitry configured to:
receive, via a communication interface coupled to a packet-switched network, signal data representing an utterance captured by a terminal device;
extract an acoustic feature sequence from the signal data and input the acoustic feature sequence to a neural network model comprising a sequence-to-sequence architecture with an acoustic encoder and a linguistic decoder to generate a token sequence, and convert the token sequence into character data;
normalize user attribute data received from the terminal device, the user attribute data indicating at least one of a perceptual characteristic and a cognitive characteristic, and select a prompt template from a plurality of stored prompt templates on the basis of the user attribute data and a processing request type;
construct a prompt data structure from the selected prompt template, generate generation input data including the prompt data structure and the character data, and input the generation input data to a generative neural network model comprising a transformer architecture with a token embedding layer, a positional encoding mechanism, a plurality of self-attention layers, and feedforward sublayers to generate output character data;
estimate an emotional state of a user associated with the terminal device by applying an emotion classification model to analysis target data derived from at least one of the signal data and image data received from the terminal device, the emotion classification model fusing at least two of a pitch contour, an energy envelope, a speaking rate, and facial action unit values to generate a probabilistic representation of the emotional state;
when the emotional state indicates at least one of confusion and anxiety, construct a rewrite prompt data structure and input the rewrite prompt data structure together with the output character data to the generative neural network model to generate adjusted character data having at least one of reduced linguistic difficulty and increased repetition;
insert prosody control markers into the adjusted character data or the output character data, the prosody control markers specifying at least one of a speech rate, a pitch value, a pause duration, and an emphasis indicator determined on the basis of the emotional state and the user attribute data;
input the adjusted character data or the output character data with the prosody control markers to a synthesis model comprising an encoder-decoder with an attention mechanism and a vocoder to generate output signal data; and
transmit the output signal data to the terminal device via the packet-switched network.

19. The system according to claim 18, wherein the circuitry updates the probabilistic representation of the emotional state over successive interactions by applying at least one of an exponential moving average and a Bayesian updating rule, and stores the output character data, the prompt data structure, and the emotional state in association with one another in a storage device for reuse in subsequent generation of output character data.

20. A method performed by circuitry of a server coupled to a packet-switched network via a communication interface, the method comprising:
receiving, via the communication interface, input data including at least one of character data and signal data from a terminal device;
converting the signal data into character data by applying a neural network model that maps an acoustic feature sequence to a token sequence;
generating a prompt data structure designating at least one of a compression operation and a transformation operation on the character data, and constructing generation input data including the prompt data structure and the character data;
inputting the generation input data to a generative neural network model to generate output character data representing a condensed or restructured form of the character data;
converting the output character data into output signal data by applying a synthesis model that generates a waveform representation; and
transmitting the output signal data to the terminal device via the packet-switched network.
